(19) United States
(12) Patent Application Publication
(10) Pub. No.: US 2025/0271313 A1
(43) Pub. Date: Aug. 28, 2025

(54) SYSTEMS, METHODS AND INFRARED NANO-SENSOR DEVICES FOR MEASURING PICO- TO MICRO-NEWTON FORCES

(71) Applicant: The Trustees of Columbia Unibersity in The City of New York, New York, NY (US)

(72) Inventors: ARTIOM SKRIPKA, Madrid (ES); Natalie Fardian Melamed, New York, NY (US); Bruce Cohen, San Francisco, CA (US); Emory Chan, Oakland, CA (US); Peter James Schuck, New York, NY (US); Changhwan Lee, New York, NY (US)

(21) Appl. No.: 19/062,836

(22) Filed: Feb. 25, 2025

Related U.S. Application Data
(60) Provisional application No. 63/558,312, filed on Feb. 27, 2024.

(51) Int. Cl. G01L 1/24; B82Y 15/00

(52) U.S. Cl. CPC G01L 1/248; B82Y 15/00

(57) ABSTRACT

Exemplary systems, methods, and devices are provided for measuring a force. Thus, the exemplary systems, methods, and devices can provide a remote optical sensor configured to measure force within the nanonewton range. The remote optical sensor can use avalanching nanoparticles to measure the force in that nanonewton range, where the brightness of the avalanching nanoparticles can be correlated to the applied force.

### CROSS REFERENCE TO RELATED APPLICATION(S)

This application relates to U.S. Provisional Patent Application Ser. No. 63/558,312, filed on Feb. 27, 2024, the entire disclosure of which is incorporated herein by reference.

### FIELD OF THE DISCLOSURE

The present disclosure relates generally to a measurement of forces, and more specifically, to exemplary systems, methods and infrared nano-sensor devices for measuring pico-to micro-newton forces.

### BACKGROUND INFORMATION

A mechanical force is an important feature for many physical and biological processes. (See, e.g., Gouveia, B. et al, 2022; Ucar, H. et al., 2021, Handler, A. & Ginty, D. D., 2021); Qui, X. & Muller, U., 2022; Marshall, K. & Patapoutian, A., 2020; Wining, K. H. & Mooney, D. J., 2017; Nonomura, K. et al., 2017; Murthy, S. E., Dubin, A. E. & Patapoutian, 2017; Lam, R. M. et al., 2023; Hill, R. Z., Loud, M. C., Dubin, A. E., Peet, B. & Patapoutian, 2022; Marshall, K. L. et al., 2020; and Zeng, W.-Z. et al., 2018.) Remote measurement of mechanical signals with high sensitivity and spatial resolution is needed for diverse applications, including robotics, (see, e.g., Li, M., Pal, A., Aghakhani, A., Pena-Francesch, A. & Sitti, M., 2022) biophysics, (see e.g., Romani, P., Valcarcel-Jimenez, L., Ferzza, C. & Supont, S., 2021; Saraswathibhatla, A., Indana, D. & Chaudhiri, O., 2023; Gomez-Gonzalez, M., Latorre, E., Arroyo, M. & Trepat, 2020; Jain, S. et al., 2020; De Belly, H., Paluch, E. K. Chalut, K., 2022; Qui, Y., Myers, D. R. & Lam, W., 2019; Killeen, A., and Bertrand, T. & Lee, C. F., 2022) energy storage, (see, e.g., de Vasconcelos, L. S. et al., 2022; Huang, W. et al., 2022; Lui, K., Lui, Y., Lin, D., Pei, A. & Cui, Y., 2018; and Doux, J. M. et al., 2020) and medicine. (See, e.g., Kaushik, S. & Persson, A., 2018; Chen, X. et al., 2018; and Zhang, J. & Reinhart-King, C.A., 2020.) Nanoscale luminescent force sensors are good at measuring piconewton forces, (see, e.g., Nickels, P. C. et al., 2016; Ringer, P. et al., 2017; Stabley, D. R., Jurchenko, C., Marshall, S. S. & Salaita, K. S., 2012; Brockman, J. M., et al., 2020; and Blanchard, A. T. & Salaita, K., 2019) while larger sensors have proven powerful in probing micronewton forces. (See, e.g., Campas, O. et al., 2014; Serwane, F. et al., 2017.) However, large gaps remain in the force magnitudes that can be probed remotely from subsurface or interfacial sites, and no individual, non-invasive sensor is capable of measuring over the large dynamic range needed to understand many systems. (See, e.g., Mehlenbacher, R. D., Kolbl, R., Lay, A. & Dionne, J. A., 2017; Sun, W., Gao, X., Lei, H. Wang, W. & Cao, Y., 2022.)

For example, engineered and biological systems, such as integrated NEMS, developing embryos, energy storage units, and migrating cells, experience multiple scales of force as a consequence of their inherently complex, multicomponent designs that span disparate length scales. (See, e.g., Vining, K. H. & Mooney, D. J., 2017; Saraswathibhatla, A., Indana, D. & Chaudhuri, O., 2023; de Vasconcelos, L. S. et al., 2022; Boocock, D., Hino, N., Ruzickova, N., Hirashima, T. & Hannezo, E., 2021; Miroshnikova, Y. A., et al., 2018; Petridou, N. I., Spiro, Z. & Heisenberg, C.-P, 2017; Van Helvert, S., Storm, C. & Friedl, P., 2018; Lui, C. et al., 2021; Midolo, L., Schliesser, A. & Fiore, A., 2018 and Tsoukalas, K., Lahijani, B. V. & Stobbe, S., 2020.) The ability to review force-dependent processes in such systems is essential for understanding their central mechanisms. (See, e.g., Killeen, A., Bertrand, T. & Lee, C. F., 2022; Polacheck, W. J. & Chen, C. S., 2016; and Wu, J., Lewis, A. H. & Grandl, J., 2017.) Remotely addressable probes are needed for in situ detection of changes or malfunction in these processes, (see, e.g., Liu, K., Liu, Y., Lin, D., Pei, A. & Cui, Y, 2018; Doux, J. M. et al., 2020; Zhang, J. & Reinhart-King, C. A., 2020; and Liu, C. et al., 2021) particularly below surfaces or at nanoscale interfaces. At such interfaces, environmental constraints or sample fragility render direct force measurements and electrical data transmission impractical or impossible.

Optical methods can excel at minimally invasive mechanical sensing. (See, e.g., Gomez-Gonzalez, M., Latorre, E., Arroyo, M. & Trepat, X., 2020; Mehlenbacher, R. D., Kolbl, R., Lay, A. & Dionne, J. A., 2017; and Wu, J., Lewis, A. H. & Grandl, J., 2017.) Optical imaging force inference methods can deduce force-induced displacements with exquisite sensitivity, yet spatial resolution is limited by diffraction, and combination with other methods is required for retrieval of absolute force. (See, e.g., Gomez-Gonzalez, M., Latorre, E., Arroyo, M. & Trepat, X., 2020.) Alternatively, single luminescent nanoprobes act as reporters of their local nanoscale environments. But the dynamic ranges of forces they can sense are limited (see, e.g., Mehlenbacher, R. D., Kolbl, R., Lay, A. & Dionne, J. A., 2017; and Sun, W., Gao, X., Lei, Hl, Wang, W. & Cao, Y, 2022), with no individual probe capable of accessing the multiple scales of force existing in many complex systems. For example, FIG. 1(a) shows a comparison of force dynamic range and sensor size with previously reported luminescent force sensors such as QD, semiconductor quantum dot 105; FRET, Forster resonance ET 110; UCNP, upconverting NP 115, etc. Additionally, while luminescent force sensors have proven to be useful in understanding the molecular forces within cells, such sensors can exhibit limited photostability—restricting continuous force monitoring, or require visible wavelengths—thus inhibiting subsurface measurements. (See, e.g., Mehlenbacher, R. D., Kolbl, R., Lay, A. & Dionne, J. A., 2017.)

Thus, it may be beneficial to provide exemplary systems, methods and infrared nano-sensors configured to measuring pico-to micro-newton forces, which can overcome at least some of the deficiencies described herein above.

### SUMMARY OF EXEMPLARY EMBODIMENTS

The following is intended to be a brief summary of the exemplary embodiments of the present disclosure, and is not intended to limit the scope of the exemplary embodiments.

In some exemplary embodiments of the present disclosure, exemplary systems, methods, and devices can be provided which can include remote optical sensors for measuring force in either or both of the nanonewton and piconewton range. These exemplary remote optical sensors may can on avalanching nanoparticles to measure forces. The avalanching nanoparticles can become brighter or dimmer as force is applied, and the measured force can be correlated to the brightness of the avalanching nanoparticles.

According to certain exemplary embodiments of the present disclosure, the exemplary systems, methods, and devices can include remote optical sensors for measuring force, which operate on near infrared wavelengths. The near infrared wavelengths can facilitate a subsurface force measurement. In additional exemplary embodiments of the present disclosure, the exemplary remote optical sensors can measure force that operate on two discrete wavelengths. These two discrete wavelengths can provide a ratio-metric readout of force.

In yet other additional exemplary embodiments of the present disclosure, exemplary systems, methods, and devices can generate a pressure map across an object. The pressure map can be generated with a plurality remote optical sensors positioned 50-100 nm apart. Moreover, the pressure map may be based on the individual pressure readings from each of the plurality of remote optical sensors. The pressure map can be generated on or in an internal portion of the object, or on a surface of the object.

These and other objects, features and advantages of the exemplary embodiments of the present disclosure will become apparent upon reading the following detailed description of the exemplary embodiments of the present disclosure, when taken in conjunction with the accompanying claims.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIG. 1(a) is an exemplary illustration comparing force dynamic range and sensor size with previously reported luminescent force sensors according to an exemplary embodiment of the present disclosure;

FIG. 1(b) is an exemplary illustration showing that interionic distance decrease and consequent energy transfer and vibrational mode energy increase within a Tm³⁺-doped NaYF4 nanoparticle under applied force leads to three optical readout modalities, depending on the intrinsic Tm³⁺-doping concentration, according to an exemplary embodiment of the present disclosure;

FIG. 1(c) is an exemplary graph showing one of three optical readout modalities provided in FIG. 1(b), according to an exemplary embodiment of the present disclosure;

FIG. 1(d) is an exemplary graph showing one of the three optical readout modalities of FIG. 1(b), according to an exemplary embodiment of the present disclosure;

FIG. 1(e) is an exemplary graph showing one of the three optical readout modalities of FIG. 1(b), according to an exemplary embodiment of the present disclosure;

FIG. 2(a) is an exemplary graph of emission (e.g., at 800 nm) versus excitation (e.g., at 1064 nm) intensities measured for a single ANP with and without applied force, according to an exemplary embodiment of the present disclosure;

FIG. 2(b is an exemplary graph of emission intensity as a function of applied force for single ANPs excited in their avalanching regime and saturation regime, according to an exemplary embodiment of the present disclosure;

FIG. 2(b) is an exemplary graph of the highest detectable force (range) and lowest detectable force (e.g., resolution) measured for 23 single-ANP compression cycles at different excitation intensities, according to an exemplary embodiment of the present disclosure;

FIG. 2(d) is an exemplary graph of two sequentially measured emission spectra (left) and their corresponding integrated intensities (right) as a function of applied force, for an ANP excited in its avalanching regime, according to an exemplary embodiment of the present disclosure;

FIG. 2(e) is an exemplary graph of emission spectra (left) and their peak magnifications (right) measured at the start and end of a compression cycle, for an ANP excited in its saturation regime, according to an exemplary embodiment of the present disclosure;

FIG. 3(a) is an exemplary graph of emission spectra as a function of applied force for a single 4% Tm³⁺ pre-ANP, according to an exemplary embodiment of the present disclosure;

FIG. 3(b) is an exemplary graph of emission intensity as a function of force for a single pre-ANP after undergoing 8 compression cycles demonstrating reproducibility, according to an exemplary embodiment of the present disclosure;

FIG. 3(c) is an exemplary graph of emission (at 800 nm) versus excitation (at 1064 nm) intensities measured for a single pre-ANP with and without applied force, according to an exemplary embodiment of the present disclosure;

FIG. 4(a) is an exemplary graph of Emission spectra collected from a single 15% Tm³⁺ piezochromic ANP with and without applied force, normalized to the 3F3 emission intensity according to an exemplary embodiment of the present disclosure;

FIG. 4(b) is an exemplary graph illustrating percent change of the 800 nm-emission/700 nm-emission ratio versus applied force for five compression cycles originating from five different piezochromic ANPs, according to an exemplary embodiment of the present disclosure;

FIG. 4(c) is an exemplary graph illustrating a mechano-optical response distribution, according to an exemplary embodiment of the present disclosure;

FIG. 4(d) is an exemplary graph illustrating a force resolution distribution, according to an exemplary embodiment of the present disclosure; and

FIG. 5(a) is an exemplary illustration showing uniaxial force versus crystal orientation for a crystal configuration, according to an exemplary embodiment of the present disclosure;

FIG. 5(b) is an exemplary illustration showing uniaxial force versus crystal orientation for a crystal configuration, according to an exemplary embodiment of the present disclosure;

FIG. 6 is an exemplary set of representative TEM images of the core and core/shell of nanoparticles, according to an exemplary embodiment of the present disclosure;

FIG. 7 is an exemplary set of emission spectra as a function of applied force, for increasing excitation intensities for a single 7% Tm³⁺ ANPs, according to an exemplary embodiment of the present disclosure;

FIG. 8 is an exemplary graph illustrating excitation power dependence of the mechano-optical response of a single 7% Tm³⁺ ANP, according to an exemplary embodiment of the present disclosure;

FIG. 9 is an exemplary graph illustrating mechano-optical response cyclability of a single ANP, according to an exemplary embodiment of the present disclosure;

FIG. 10(a) is an exemplary graph illustrating single ANP force range, according to an exemplary embodiment of the present disclosure;

FIG. 10(b) is an exemplary graph illustrating single ANP force resolution, according to an exemplary embodiment of the present disclosure;

FIG. 10(c) is an exemplary graph illustrating single ANP intrinsic NES pump power dependence, according to an exemplary embodiment of the present disclosure;

FIG. 11 is an exemplary graph illustrating ensemble (thin dry film) measurements of pre-ANPs, according to an exemplary embodiment of the present disclosure;

FIG. 12(a) is an exemplary graph illustrating mechano-optical response cyclability of single pre-ANPs, according to an exemplary embodiment of the present disclosure;

FIG. 12(b) is an exemplary graph illustrating mechano-optical response cyclability of single pre-ANPs, according to an exemplary embodiment of the present disclosure;

FIG. 13(a) is an exemplary graph illustrating mechano-optical response cyclability of single pre-ANPs, according to an exemplary embodiment of the present disclosure;

FIG. 13(b) is an exemplary graph illustrating mechano-optical response cyclability of single pre-ANPs, according to an exemplary embodiment of the present disclosure;

FIG. 14 is an exemplary set of illustrations for repeating pre-ANP to ANP transformations, according to an exemplary embodiment of the present disclosure;

FIG. 15(a) is an exemplary set of graphs illustrating 700nm-emission as a function of Tm³⁺ concentration, according to an exemplary embodiment of the present disclosure;

FIG. 15(b) is an exemplary graph illustrating of 800 nm-emission/700 nm-emission ratio versus Tm³⁺ concentration, according to an exemplary embodiment of the present disclosure;

FIG. 16(a) is an exemplary graph illustrating a single piezochromic ANP compression cycle, according to an exemplary embodiment of the present disclosure;

FIG. 16(b) is an exemplary graph illustrating a single piezochromic ANP compression cycle, according to an exemplary embodiment of the present disclosure;

FIG. 16(c) is an exemplary graph illustrating a single piezochromic ANP compression cycle, according to an exemplary embodiment of the present disclosure;

FIG. 16(d) is an exemplary graph illustrating a single piezochromic ANP compression cycle, according to an exemplary embodiment of the present disclosure;

FIG. 17, is an exemplary illustration of mechano-optical response of different single piezochromic ANPs according to an exemplary embodiment of the present disclosure;

FIG. 18(a) is an exemplary illustration for mechano-optical response cyclability of a single piezochromic ANP, according to an exemplary embodiment of the present disclosure;

FIG. 18(b) is an exemplary illustration for mechano-optical response cyclability of a single piezochromic ANP, according to an exemplary embodiment of the present disclosure;

FIG. 18(c) is an exemplary illustration for mechano-optical response cyclability of a single piezochromic ANP, according to an exemplary embodiment of the present disclosure;

FIG. 18(d) is an exemplary illustration for mechano-optical response cyclability of a single piezochromic ANP, according to an exemplary embodiment of the present disclosure;

FIG. 18(e) is an exemplary graph illustrating 800-nm-emission/700-nm-emission ratio versus applied force for three force cycles, according to an exemplary embodiment of the present disclosure;

FIG. 19(a) is an exemplary graph illustrating mechano-optical response versus cycle # for single piezochromic ANPs, according to an exemplary embodiment of the present disclosure;

FIG. 19(b) is an exemplary graph illustrating mechano-optical response versus cycle # for single piezochromic ANPs, according to an exemplary embodiment of the present disclosure;

FIG. 19(c) is an exemplary graph illustrating mechano-optical response versus cycle # for single piezochromic ANPs according to an exemplary embodiment of the present disclosure;

FIG. 19(d) is an exemplary graph illustrating mechano-optical response versus cycle # for single piezochromic ANPs according to an exemplary embodiment of the present disclosure;

FIG. 20(a) is an exemplary graph illustrating mechano-optical response versus integration time for single piezochromic ANPs according to an exemplary embodiment of the present disclosure;

FIG. 20(b) is an exemplary graph illustrating mechano-optical response versus integration time for single piezochromic ANPs according to an exemplary embodiment of the present disclosure;

FIG. 20(c) is an exemplary graph illustrating mechano-optical response versus integration time for single piezochromic ANPs according to an exemplary embodiment of the present disclosure;

FIG. 20(d) is an exemplary graph illustrating mechano-optical response versus integration time for single piezochromic ANPs according to an exemplary embodiment of the present disclosure;

FIG. 21(a) is an exemplary graph illustrating mechano-optical parameter distributions for single piezochromic ANPs according to an exemplary embodiment of the present disclosure;

FIG. 21(b) is an exemplary graph illustrating mechano-optical parameter distributions for single piezochromic ANPs according to an exemplary embodiment of the present disclosure;

FIG. 21(c) is an exemplary graph illustrating mechano-optical parameter distributions for single piezochromic ANPs according to an exemplary embodiment of the present disclosure;

FIG. 22(a) is an exemplary graph illustrating ANP, pre-ANP, and piezochromic ANP mechano-optical intrinsic NES versus excitation intensity according to an exemplary embodiment of the present disclosure;

FIG. 22(b) is an exemplary graph illustrating ANP, pre-ANP, and piezochromic ANP mechano-optical range versus excitation intensity according to an exemplary embodiment of the present disclosure; and

FIG. 22(c) is an exemplary graph illustrating ANP, pre-ANP, and piezochromic ANP mechano-optical resolution versus excitation intensity according to an exemplary embodiment of the present disclosure.

Throughout the drawings, the same reference numerals and characters, unless otherwise stated, are used to denote like features, elements, components or portions of the illustrated embodiments. Moreover, while the present disclosure will now be described in detail with reference to the figures, it is done so in connection with the illustrative embodiments and is not limited by the particular embodiments illustrated in the figures and the appended claims.

### DETAILED DESCRIPTION OF EXEMPLARY EMBODIMENTS

The following description of exemplary embodiments provides non-limiting representative examples referencing numerals to particularly describe features and teachings of different exemplary aspects and exemplary embodiments of the present disclosure. The exemplary embodiments described should be recognized as capable of implementation separately, or in combination, with other exemplary embodiments from the description of the exemplary embodiments. A person of ordinary skill in the art reviewing the description of the exemplary embodiments should be able to learn and understand the different described aspects of the present disclosure. The description of the exemplary embodiments should facilitate understanding of the exemplary embodiments of the present disclosure to such an extent that other implementations, not specifically covered but within the knowledge of a person of skill in the art having read the description of embodiments, would be understood to be consistent with an application of the exemplary embodiments of the present disclosure.

Exemplary systems, methods, and devices according to the exemplary embodiments of the present disclosure provide Tm3+-doped avalanching nanoparticle (see, e.g., Lee, C., et al., 2021) force sensors that can be addressed remotely by deeply penetrating near-infrared (NIR) light and can detect piconewton to micronewton forces with a dynamic range spanning more than four orders of magnitude. Using atomic force microscopy coupled with single-nanoparticle optical spectroscopy, systems, methods and sensors according to the exemplary embodiments of the present disclosure can characterize the mechanical sensitivity of the photon avalanching process and reveal its exceptional force responsiveness. By manipulating the Tm3+ concentrations and energy transfer within the nanosensors, the systems, methods and sensors according to the exemplary embodiments of the present disclosure can demonstrate different optical force-sensing modalities, including mechanobrightening and mechanochromism. The adaptability of these nanoscale optical force sensors according to the exemplary embodiments of the present disclosure, along with their multiscale sensing capability, enable operation in the dynamic and versatile environments present in real-world, complex structures spanning biological organisms to nanoelectromechanical systems (NEMS).

To provide a remote force sensing system that overcomes current limitations, the systems, methods and sensors according to the exemplary embodiments of the present disclosure can take advantage of unexpected observations that avalanching nanoparticles (ANPs) undergo significant changes in emission when tapped with AFM tips. ANPs (see, e.g., Lee, C. et al., 2021; Bednarkiewicz, A., Chan, E. M., Kotulska, A., Marciniak, L. & Prorok, K., 2019; Dudek, M. et al., 2022; Skripka, A. et al., 2023; Liang, Y. et al., 2022; and Zhang, Z. et al., 2023) are a class of steeply nonlinear upconverting nanoparticles (UCNPs), which are lanthanide-based nanocrystal phosphors that convert multiple sequentially absorbed NIR photons into higher-energy emitted photons, and show no overlap with sample autofluorescence, no on-off blinking, and no measurable photobleaching, even under prolonged lasing or single-particle excitation. (See, e.g., Wu, S. et al., 2009; Park, Y. I. et al., 2009; Cohen, B. E., 2010; Ostrowski, A. D. et al., 2012; Gargas, D. J. et al., 2014; and Lee, C. et al., 2023.) Because of their steeply nonlinear relation s between pump power and emission intensity, ANPs are able to amplify minute changes in signal input to giant changes in output (i.e., Iₒᵤₜ=Iᵢₙ^{s}; where I is intensity and nonlinear order s>15). (See, e.g., Lee, C. et al, 2021; Bednarkiewicz, A., Chan, E. M., Kotulska, A., Marciniak, L. & Prorok, K., 2019; Dudek, M. et al., 2022; Skripka, A. et al., 2023; Liang, Y. et al., 2022; and Zhang, Z. et al., 2023.) Recent studies have shown that both the photon avalanche threshold and the degree of nonlinearity s can be modified by manipulating lanthanide concentration. (See, e.g., Lee, C. et al., 2021; Bednarkiewicz, A., Chan, E. M., Kotulska, A., Marciniak, L. & Prorok, K., 2019; and Dudek, M. et al., 2022.)

To determine the mechano-optical response of Tm³⁺-doped NaYF₄ ANPs, exemplary embodiments of the present disclosure studied them as single ANPs under ambient conditions, using atomic force microscope (AFM) tips for force application, in combination with an inverted optical microscope for NIR excitation and emission measurements. To minimize or reduce quenching or energy transfer (ET) between ANP and tip or other surrounding components, (see, e.g., Fischer, S., Bronstein, N. D., Swabeck, J. K. Chanb, E. M. & Alvisatos, A. P., 2016; and Johnson, N.J. et al., 2017) exemplary embodiments synthesized all ANPs with thick (>5 nm) undoped NaYF₄ shells (See Exemplary Nanoparticle Size Distributions).

### Exemplary Nanoparticle Size Distributions

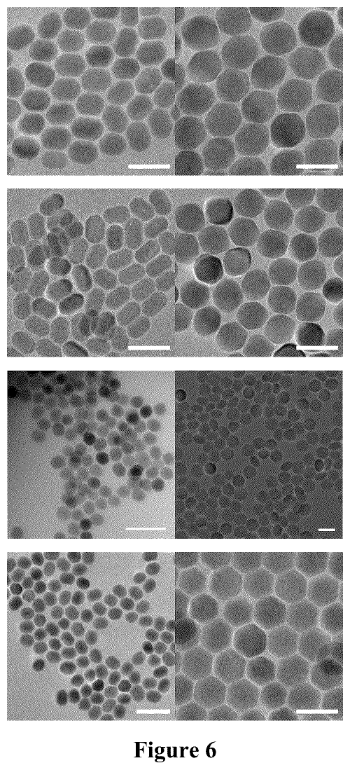

A number of considerations were taken into account when synthesizing the particles (see, e.g., Table 1 and FIG. 6):
to eliminate or extensively reduce energy transfer from the ANP emitters to the tip or other surrounding components, (see, e.g., Fischer, S., Bronstein, N. D., Swalbeck, J. K., Chan, E. M., Alivisatos, A. P., 2016; and Johnson, N. J., He, S., Diao, S., Chan, E. M., Dai, H., Almutairi, A., 2017) and vice versa, all the particles of exemplary embodiments were equipped with a thick (average thickness˜7 nm) optically inactive shell.
to comply with the stricter definition of a nanoparticle, all the particles of exemplary embodiments were synthesized such that all three dimension-lengths, including the shells, were <50 nm (30 nm≤core+shell major axis≤45 nm).
   FIG. 6 shows representative TEM images of the core and core/shell nanoparticles. The images in the left column show NaYF4: x % Tm3+ cores while the images in the right column show corresponding core/shell nanoparticles with NaYF4: 20% Gd³⁺ shells. The Particle sizes are provided in Table 1.

To comply with these strict limitations, single particle brightness was compensated for in exemplary embodiments, as most of the limited volume of each particle was used for optically inactive shell material. For example, for the 7% Tm³⁺ particle, 89% of the total particle volume is used up by the thick shell, while only 11% of the particle volume includes optically active Tm³⁺ ions.

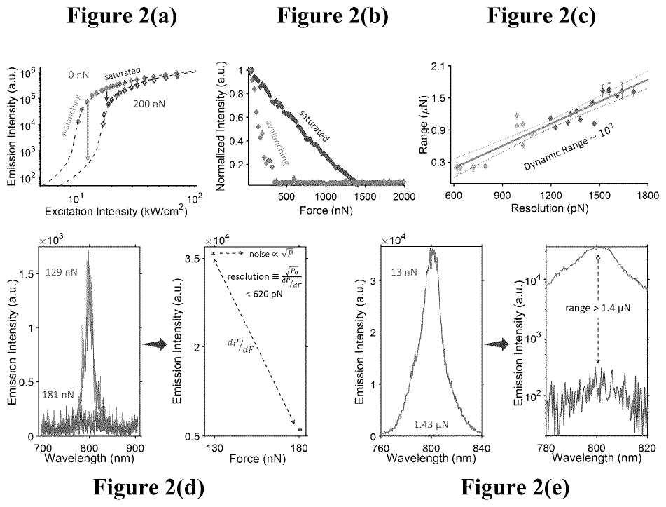

The brightness of the particles may be increased and hence increase the force sensitivity (as it is directly proportional to the inverse of the square-root of the ambient brightness for both ratiometric and intensity-based measurements, as reflected by the equation illustrated in FIG. 2(d)) and force range by changing the core-shell volume proportions and/or particle size.

### Exemplary Force Resolution and Noise Equivalent Sensitivity (NES) Derivation

### Exemplary Optical Sensor Resolution and NES

The derivation of the Noise Equivalent Sensitivity (NES) below is based on the work of Dionne, et al. for optical sensors, (see, e.g., Casar, J. R., McLellan, C. A., Siefe, C., Dionne, J. A., 2020; and McLellan, C. A., Siefe, C., Casar, J. R., Peng, C. S., Fisher, S., Lay, A., Parakh, A., Ke, F.; Gu, X. W., Mao, W., 2022) which is based on similar derivations for optical magnetic field sensors. (See, e.g., Dreau, A., Lesik, M., Rondin, L., Spinicelli, P., Arcizet, O., Roch, J.-F, Jacques, V., 2011; and Taylor, J. M., Cappelllaro, P., Childress, L.; Jiang, L., Budker, D., Hemmer, P., Yacoby, A., Walsworth, R., Lukin, M., 2008.)

The (force, F) resolution (resolution_{F}) of a (mechanical) sensor is defined as the minimal detectable change in stimuli (F). As per the definition, it depicts the amount of stimuli (F) needed to create a signal(S) equal to the noise on the signal (ΔS):

$${resolution}_{F} ≡ Δ S / ( dS / dF ) \qquad ( 1 )$$

In the case of an optical sensor expressing Poissonian noise distribution, the signal to noise ratio (SNR) of the optical signal scales as \sqrt{S}, where S is the number of photons collected. Increasing the number of photons can be achieved by increasing the integration time of the measurement or the brightness of the sensor. For a given sensor, the minimal detectable change will hence scale with the inverse square root of the integration time (t). It is therefore useful to use the NES as a figure of merit, which is the resolution of a measurement in a 1 Hz bandwidth.

The derivation of the force resolution and NES for the case of an intensity-based measurement, and a ratiometric-based measurement, are given below.

### Exemplary Intensity-Based Measurement Force Resolution and NES

When the signal is the change in photon intensity from the sensor, the signal is:

$$P = {I}_{0} t ( 1 + RF ) \qquad ( 2 )$$

Where P is the number of photons collected ([P]=cnts), I₀ is the starting photon count rate of the sensor ([I₀]=cnts/s), t is the integration time ([t]=s), R is the response of the intensity ([R]=1/nN), and F is the applied force ([F]=nN).

At zero applied force, the error on the measurement (ΔP) is the shot noise of the photons collected, which scales as \sqrt{P} (see above):

$$Δ P = {σ}_{P} = \sqrt{P} = \sqrt{{I}_{0} t} \qquad ( 3 )$$

Therefore, the resolution of the measurement (resolution_{F}) is:

$${resolution}_{F} ≡ Δ P / \frac{dP}{dF} = \frac{\sqrt{{I}_{0} t}}{{I}_{0} t \vert R \vert} = \frac{1}{\vert R \vert \sqrt{{I}_{0} t}} \qquad ( 4 )$$

The NES is found by multiplying by \sqrt{t} on each side:

$$NES = \frac{1}{\vert R \vert \sqrt{{I}_{0}}} \qquad ( 5 )$$

### Exemplary Ratiometric-Based Measurement Force Resolution and NES

For a ratiometric measurement with a linear response function, the signal can be written as:

$$α ≡ \frac{{L}_{1}}{{L}_{2}} ≡ {α}_{0} ( 1 + RF ) \qquad ( 6 )$$

where L₁ and L₁ are the photons collected from the two distinct wavelength bands for ratiometric comparison, and

$${α}_{0} ≡ \frac{{L}_{{1}_{0}}}{{L}_{{2}_{0}}}$$

is their initial ratio, R is the sensor response, and F is the applied force.

The initial photon count number (initial brightness) is:

$${P}_{0} = {I}_{0} t ≡ {L}_{{1}_{0}} + {L}_{{2}_{0}} \qquad ( 7 )$$

where I₀ is the initial total count rate of the sensor and t is the integration time.

The error on the initial signal due to photon shot noise is:

$$Δα = {α}_{0} \sqrt{{( \frac{{σ}_{{L}_{{1}_{0}}}}{{L}_{{1}_{0}}} )}^{2} + {( \frac{{σ}_{{L}_{{2}_{0}}}}{{L}_{{2}_{0}}} )}^{2}} \qquad ( 8 )$$

Hence, the resolution of the ratiometric measurement (resolution_{F}) is:

$${resolution}_{F} ≡ Δα / \frac{d α}{dF} = \frac{1 + {α}_{0}}{\vert R \vert \sqrt{{I}_{0} t {α}_{0}}} \qquad ( 9 )$$

The NES is found by multiplying by \sqrt{t} on each side:

$$NES = \frac{1 + {α}_{0}}{\vert R \vert \sqrt{{I}_{0} {α}_{0}}} \qquad ( 10 )$$

### Exemplary Configuration Considerations and the Intrinsic NES

Most or all of the force resolution derivations utilized with the systems, methods and sensors according to the exemplary embodiments of the present disclosure can be calculated for the raw collected signal, without factoring in our setup collection efficiency (e.g., 1%-5%**), the wavelength-specific quantum efficiency (QE) of our EM-CCD camera (e.g., 42% at 800 nm), or the EM-CCD Gain (EMₘₐₓ=1,000%).

Beneficial collection path throughput (based on the system components)=38% (emitted photons reaching the high-NA objective front lens for N.A.=1.4 and n_{immersion oil}=1.51, and when the particle emission is collected from beneath the sample)*50% (objective transmittance at 800 nm)*(97%)¹⁰ (10 mirrors)*90% (950SP dichroic mirror)*(97%)³ (945SP, 950SP, 633LP filters)*(97%)³ (3 spectrograph mirrors)*50% (spectrometer grating)=5%.

To correct for these, the derived single particle emission can be:

$$P = \frac{Signal}{EM \cdot QE \cdot {Throughput}_{Coll .}} = \frac{Signal}{10 \cdot 0.42 \cdot 0.05} = \frac{Signal}{0.21} = 4.8 * Signal .$$

In fact, the collection efficiency of the setup utilized in exemplary embodiments is lower than 5% (which is the optimized calculated throughput, based on the system components—see above), and closer to 1%. Thus, the actual single particle emission intensity is roughly:

$$P = \frac{Signal}{EM \cdot QE \cdot {Throughput}_{Coll .}} = \frac{Signal}{10 \cdot 0.42 \cdot 0.01} = \frac{Signal}{0.042} = 23.8 * Signal .$$

Therefore, the force resolution

$$( ∼ \frac{1}{\sqrt{{I}_{0}}} )$$

may reach 4.9× higher sensitivities/resolutions. In any case, the force resolution values given are for the most conservative case, where it is assumed that P=Signal.

The intrinsic NES values given can be determined or otherwise calculated based on the raw signal resolutions measured in ecemplary embodiments, extrapolated for setup considerations (4.9×) and oleic-acid removal (3×), and multiplied by \sqrt{t}, while t is the integration time of the measurement.

### Exemplary ANP Extreme Nonlinearity Offers Access to a Wide Dynamic Range of Forces Spanning 4 Orders of Magnitude

The lowest laser intensity at which photon avalanche is observed depends on ANP Tm³⁺ concentration, shifting to higher threshold intensities as doping content increases. (See, e.g., Lee, C. et al., 2021; Bednarkiewicz, A., Chan, E. M., Kotulska, A., Marciniak, L. & Prorok, K., 2019; and Dudek, M. et al., 2022.) Exemplary embodiments of the present disclosure hypothesize that the same trend can be observed when applying force upon an ANP, as compressive force should decrease the interionic distances within the ANP, and hence effectively increase its concentration (See Exemplary Force-Induced Interionic Distance section below)

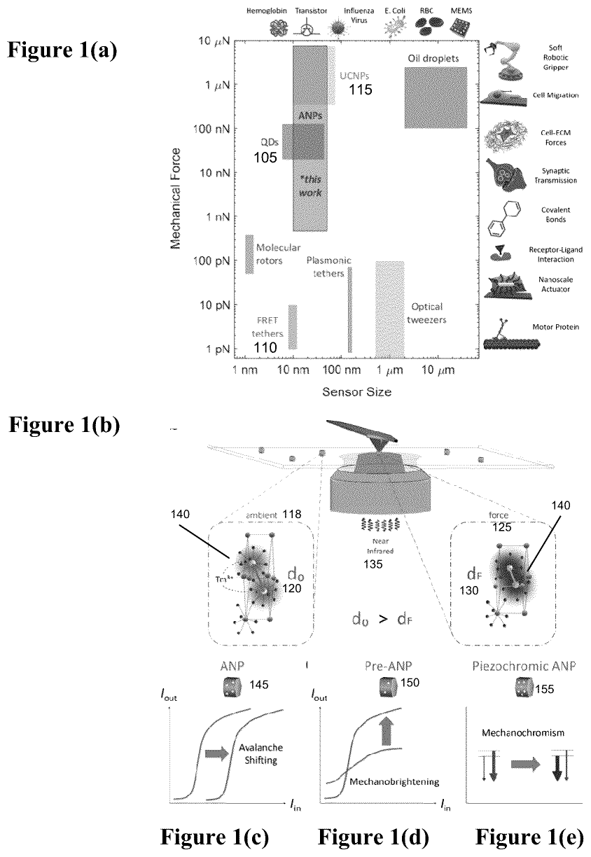

In addition, a decrease in interionic distances should increase the energy of the ANP vibrational modes and hence the nonradiative rates, (see, e.g., Wisser, M. D. et al., 2015; Lage, M. M., Moreira, R. L., Matinaga, F. M. & Gesland, J.-&, 2005; and van Swieten, T. P. et al., 2022) further shifting the avalanche onset to higher excitation intensities (see, e.g., Lee, C. et al., 2021) with application of force. FIG. 1(b) provides an exemplary diagram showing the relationship between interionic distance (d) decrease and consequent energy transfer (ET) and vibrational mode energy increase within a Tm³⁺-doped NaYF4 nanoparticle (NP) under applied force, thereby leading to three optical readout modalities depending on an intrinsic Tm³⁺-doping concentration. For example, under ambient conditions 118, there may be an interionic distance do 120, and under a force 125, the interionic distance may change to df 130. Interionic distance df 130 can be smaller than do 120 as a result of force 125. Under near infrared light 135, an higher optical readout 140 can be observed under an interionic distance df 130 as compared to do 120.

FIG. 1(c) provides a graph showing that moderately doped (4.5%-8% Tm³⁺) ANPs 145 can exhibit steeply nonlinear emission versus excitation curves that can shift with applied force, enabling observation of large emission signal change with minute applied force. FIG. 1(d) shows that lower doped (4% Tm³⁺) pre-ANPs 150 can transform from their energy-looping state to an avalanching state, prompting substantial emission enhancement with applied force. FIG. 1(e) shows that highly doped (15% Tm³⁺) piezochromic ANPs 155 can emit light from two Tm³⁺ energy levels with intensities that vary differently under applied force, enabling ratiometric optical readout of applied force.

To verify, the systems, methods and sensors according to the exemplary embodiments of the present disclosure can measure the emission versus excitation for a single ANP, with and without applied force. For example, FIG. 2(a) shows a graph of emission (at 800 nm) versus excitation (at 1064 nm) intensities measured for a single ANP with and without applied force. The dashed lines in this graph are photon avalanche differential rate equation model (see, e.g., Lee, C. et al., 2021) fits (Table 2). The larger change in signal per unit force, represented by the left arrow, occurs in the avalanching regime of the ANP, while the smaller change in signal per unit force, represented by the right arrow, occurs in the saturation regime of the ANP.

Thus, with the systems, methods and sensors according to the exemplary embodiments of the present disclosure, the excitation-emission curve measured at an applied force as low as 200 nN is dramatically shifted from one measured without applying force; the same emission intensity measured at ambient force is acquired at an excitation intensity 62% larger when 200 nN are applied upon the ANP.

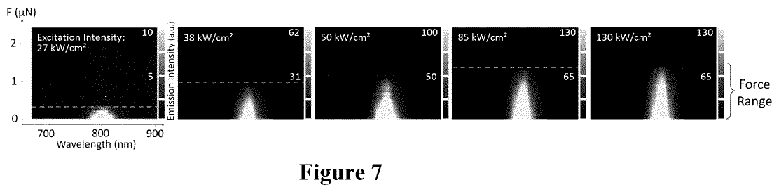

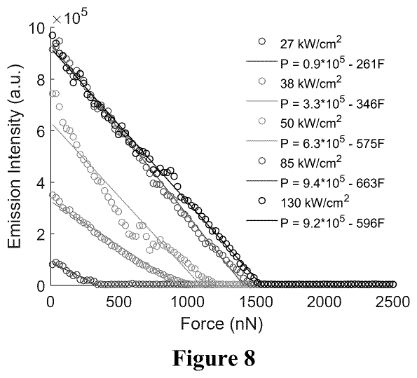

The drastic shift of the ANP excitation-emission curve with force, according to the exemplary embodiments, implies that a large change in ANP emission will be observed per unit force for a given pump power, offering high mechano-optical sensitivity. To quantify the response, the systems, methods and sensors according to the exemplary embodiments of the present disclosure can measure the force-dependent optical emission for a series of forces, at a constant pump power. Exemplary embodiments can repeat this measurement for different pump powers, in the avalanching regime (where the degree of nonlinearity s>>2) and in the saturation regime (where s˜2) of the single ANPs. FIG. 2(b) provides a graph showing emission intensity as a function of applied force for single ANPs excited in their avalanching regime and saturation regime. For example, the mechano-optical response of an ANP can be exceptionally large for all pump powers, enabling the detection of 620 pN forces in the avalanching regime and single-digit nN forces in the saturation regime. FIG. 2(c) shows a graph of highest detectable force (range) and lowest detectable force (resolution) measured for 23 single-ANP compression cycles at different excitation intensities. The error bars are derived from the 95% confidence bounds on the linear fits to the emission intensity versus applied force graphs (as illustrated in FIG. 2(b)), each containing 10-200 data points. FIG. 2(d) shows two sequentially measured emission spectra (left) and their corresponding integrated intensities (right) as a function of applied force, for an ANP excited in its avalanching regime. The noise-defined resolution is depicted (P—photon counts, F—force). FIG. 7 shows a set of emission spectra as a function of applied force, for increasing excitation intensities, for single 7% Tm³⁺ ANPs. At each excitation intensity, 100 force-dependent optical spectra can be measured per 2.5 μN force ramp. The accessible force range (dashed line), and the relative brightness of the particle for each excitation intensity correlate with the particle's avalanching behavior. (See Exemplary Force Resolution and Noise Equivalent Sensitivity (NES) Derivation, and Exemplary Materials and Methods). FIG. 8 shows excitation power dependence of the mechano-optical response of a single 7% Tm³⁺ ANP. Each compression cycle (measured at a different excitation intensity) can consist of 100 data points, derived from 100 force-dependent optical spectra measured at 3 s acquisition times. The emission intensity is the 800 nm emission integrated intensity (760 nm<λ<840 nm). Force increment step size can be 25 nN.

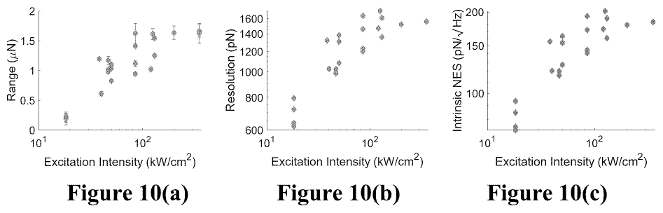

To determine the dynamic range of forces measurable with an ANP, the systems, methods and sensors according to the exemplary embodiments of the present disclosure can apply 0 to 2.5 μN forces upon each ANP, and can optically measure the lowest and highest detectable forces. The lowest detectable force, e.g., the noise-defined resolution, is shot-noise-limited and is fundamentally dependent on the intrinsic noise-equivalent sensitivity (NES) (see, e.g., Casar, J. R., McLellan, C. A., Siefe, C. & Dionne, J. A., 2020; and McLellan, C. A. et al., 2022) of the ANP, and affected by integration time and setup details (See Exemplary Force Resolution and Noise Equivalent Sensitivity (NES) Derivation). The systems, methods and sensors according to the exemplary embodiments of the present disclosure can detect 620 pN within 3 s, and the calculated intrinsic NES of an ANP may reach 73 pN/\sqrt{Hz} within the avalanching regime of the ANP, as illustrated by FIG. 2(d). Also, FIGS. 10(a)-10(c) show exemplary graphs of single ANP force range, force resolution, and intrinsic NES pump power dependence. Specifically, FIG. 10(a) shows the highest detectable force (range) measured, FIG. 10(b) shows the lowest detectable force (resolution) measured, and FIG. 10(c) shows calculated intrinsic NES—all as a function of excitation intensity, for 23 7% Tm³⁺ single-ANP compression cycles, each consisting of 10-200 force-emission data points. (See also Exemplary Force Resolution and Noise Equivalent Sensitivity (NES) Derivation).

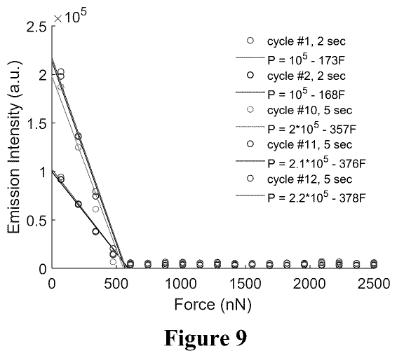

According to the exemplary embodiments, the highest detectable force, namely the force range, is dark-noise-limited and is fundamentally dependent on the intrinsic quantum yield of the ANP and the nanocrystal elastic limit. Exemplary embodiments can detect 1.7 μN of force within the saturation regime of these ANP compositions. In exemplary embodiments, there is observation of no optical degradation resulting from plastic deformation or photobleaching, for up to 25 compression cycles measured within this 2.5 μN force range and these measurement times and pump powers. For example, FIG. 9 shows a graph of mechano-optical response cyclability of a single ANP where repeating compression cycles were measured for a single 7% Tm³⁺ ANP at a specific excitation power (27 kW/cm²), for different acquisition times. Each compression cycle consists of 20 data points, derived from 20 force-dependent optical spectra measured at 2 s (cycles 1, 2) and 5 s (cycles 10, 11, 12) acquisition times. The emission intensity is the 800 nm emission integrated intensity (760 nm<λ<840 nm). FIG. 9 shows that the force-dependent optical response is repeatable, for the 2.5-μN-force cycles applied. No photodegradation or plastic deformation is measured under these excitation and mechanical conditions, for up to 25 measured cycles per particle. The difference in apparent ambient particle brightness, and hence emission-force graphs, can derive from the different acquisition times. Normalization by the acquisition time can yield similar intrinsic NES values for all cycles. (See also Exemplary Force to Pressure Conversion Estimates and the Plastic Deformation Threshold). For example, the highly nonlinear mechano-optical response, which is maximized at the avalanching regime, can facilitate the detection of hundreds of pN to hundreds of nN forces at lower pump powers. Meanwhile, the ANP high emission, which is maximized at the saturation regime, facilitates the detection of single-digit nN to single-digit μN at higher pump intensities, as highlighted by FIGS. 2(c)-2(e), where FIG. 2(e) shows emission spectra (left) and their peak magnifications (right) measured at the start and end of a compression cycle, for an ANP excited in its saturation regime. The same large dynamic range spanning three orders of magnitude of force is maintained throughout all pump intensities for all single ANPs measured, as reflected in FIG. 2(c).

### Exemplary Force-Induced Interionic Distance-Poisson's Ratio Consideration

The average interionic distance between emitters for a concentration x ([x]=fraction atoms) of lanthanide emitters within a hexagonal phase NaYF₄ particle (a=5.96 Å and c=3.53 Å) (see, e.g., Zhao, J., Chen, X., Chen, B., Luo, X., Sun, T., Zhang, W., Wang, C., Lin, J., Su, D., Qiao, X, 2019) is (see e.g., Fischer, S.; Frohlich, B., Kramer, K. W., Goldschmidt, J. C., 2014):

$${d}_{β - {NaYF}_{4}} = {( \frac{{a}^{2} c}{\sqrt{3} x} )}^{\frac{1}{3}} \qquad ( 11 )$$

From high-pressure studies of NaYF₄ (see, e.g., Grzechnik, A., Bouvier, P., Mezouar, M., Mathews, M., Tyagi, A., Kohler, J., 2002), one may derive the Bulk Modulus K of hexagonal phase NaYF₄:

$$K ≡ - V \frac{dP}{dV} = 133 GPa$$

(where P is pressure and V is the initial volume). Lay et al. (see, e.g., Lay, A., Wang, D. S., Wisser, M. D., Mehlenbacher, R. D., Lin, Y., Goodman, M. B., Mao, W. L., Dionne, J.A., 2017) have measured an average Elastic Modulus of 272 GPa for cubic phase NaYF4. In the absence of uniaxial force studies of hexagonal phase NaYF₄, exemplary embodiments assumed E=272 GPa for the calculations.

Using these parameters, the Poisson Ratio v of hexagonal phase NaYF₄ is assumed to be:

$$v ≡ \frac{3 K - E}{6 K} = 0.16 \qquad ( 12 )$$

Note that the attained v value falls in line with an expected Poisson Ratio for a ceramic material.

In the case of uniaxial stress:

$$v ≡ - \frac{d {ε}_{trans}}{d {ε}_{axial}}$$

(where v is the Poisson Ratio, εₜᵣₐₙₛ is transverse strain, εₐₓᵢₐₗ is axial strain, and positive strain indicates extension and negative strain indicates contraction).

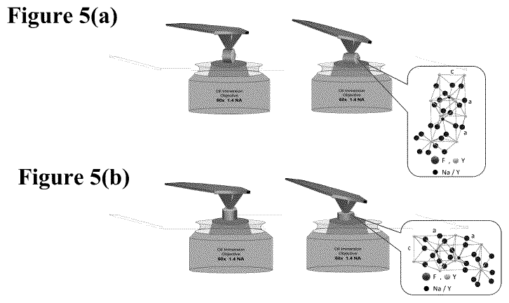

Hence, for uniaxial force F applied perpendicular to the crystal c axis, as reflected in FIGS. 5(a) and 5(b) showing exemplary illustration for uniaxial force versus crystal orientation (with FIG. 5(b) showing an applied axial force):

$$v = - \frac{Δ c / c}{Δ a / a} \qquad ( 13 )$$

### Yielding:

$$Δ c = - \frac{{vc}_{0} Δ a}{{a}_{0}} \qquad ( 14 )$$

From the Elastic Modulus

$$E ≡ \frac{P}{{ε}_{axial}} = \frac{F / A}{Δ a / {a}_{0}} ,$$

it is possible to derive the length contraction in the crystal axis a parallel to the applied force F:

$$Δ a = \frac{{a}_{0} F}{EA} \qquad ( 15 )$$

For a tip of radius r˜10 nm, the tip-particle contact area is A=πr²=314 nm². It follows that:

$$Δ a = \frac{{a}_{0} F}{EA} = \frac{0.596 nm \cdot F}{272 GPa \cdot 314 {nm}^{2}} = 6974.731 \cdot F \qquad ( 16 )$$

Substituting the derived value in (6) for Δa in (4), the length extensions of the crystal axes c and a perpendicular to the applied force F are:

$$Δ c = - \frac{{vc}_{0} Δ a}{{a}_{0}} = - \frac{0.16 \cdot 0.353 nm \cdot 6974.731 \cdot F}{0.596 nm} = - 660.961 \cdot F \qquad ( 17 )$$

$$Δ {a}^{′} = - \frac{{va}_{0} Δ a}{{a}_{0}} = - 0.16 \cdot 6974.731 \cdot F = - 1115.957 \cdot F \qquad ( 18 )$$

Using the derived values in (6), (7) and (8) for a_{F}=a₀−Δa, a_{F}′=a₀−Δa′, and c_{F}=c₀−Δc (when a_{F} is the contracted a length and c_{F} and a_{F}′ are the extended c and a lengths under positive force F), and substituting these for a and c in (1), the average interionic distance under force F when F⊥c is:

$${d}_{F} = {( \frac{{a}_{F} \cdot {a}_{{F}^{′}} \cdot {c}_{F}}{\sqrt{3} x} )}^{\frac{1}{3}} = {( \frac{( {a}_{0} - 6974.731 \cdot F ) ( {a}_{0} + 1115.957 \cdot F ) ( {c}_{0} + 660.961 \cdot F}{\sqrt{3} x} )}^{\frac{1}{3}} \qquad ( 19 )$$

In the same manner, the average interionic distance under force F when F∥c (as reflected in FIG. 5(b)) is:

$${d}_{F} = {( \frac{{( {a}_{0} + 1115.957 \cdot F )}^{2} ( {c}_{0} - 4131.007 \cdot F )}{\sqrt{3} x} )}^{\frac{1}{3}} \qquad ( 20 )$$

For [F]=N, and [d_{F}], [a₀], and [c₀]=nm

In both exemplary configurations, the average distance between emitters can be reduced upon force application, even when taking into account extension of the lattice parameters within the plane perpendicular to the applied force. The maximal average strain

$$( ε = \frac{Δ d}{{d}_{0}} )$$

induced in the measurements is about −0.68%.

### Exemplary Force to Pressure Conversion Estimates and the Plastic Deformation Threshold

In exemplary measurements, the tip-particle contact area can be determined by the tip radius (the smaller of the two radii—Rₜᵢₚ and R_{UCNP}). For a conservative assumption of a tip radius of 10 nm (assuming tip bluntness is exacerbated by consecutive compression cycles, as silicon will undergo plastic deformation at ˜3 GPa, which is below the highest amount of pressure applied in exemplary embodiments, even when assuming a sharp tip of 6 nm radius, as stated on the tip specifications), the largest pressure applied is:

$${P}_{max} = \frac{{F}_{max}}{π {R}^{2}} = \frac{2.5 μ N}{π \cdot {( 10 nm )}^{2}} = 8 GPa$$

This, along with the plastic deformation threshold found in previous works for hexagonal-phase NaYF4 (˜10 GPa (see, e.g., Grzechnik, A., Bouvier, P., Mezouar, M., Mathews, M., Tyagi, A., Kohler, J., 2002; Lay, A., Wang, D. S., Wisser, M. D., Mehlenbacher, R. D., Lin, Y., Goodman, M. B., Mao, W. L., Dionne, J. A., 2017; and Wisser, M. D., Chea, M., Lin, Y., Wu, D. M., Mao, W. L., Salleo, A., Dionne, J. A., 2015), can indicated that the maximum force applied in exemplary embodiments is still in the particles' elastic regime. Hence, no plastic deformation of the particles is expected within a 2.5 μN range. By increasing ANP brightness (e.g., by increasing core size), or, alternately, by decreasing the detector dark noise, one may extend the accessible force range further than 2.5 μN. For example, for a 50-nm-wide ANP, one may extend the range to:

$${F}_{max} = {P}_{max - elastic} \cdot π {R}^{2} = 10 GPa \cdot π \cdot {( 25 nm )}^{2} = 20 μ N$$

The lowest force detected with conditions in exemplary embodiments (with pre-ANPs, at 3 s integration time) was 475 pN. The estimated lowest detected compressive pressure (for a conservative assumption of tip radius of 10 nm) is thus:

$${resolution}_{P} = \frac{{resolution}_{F}}{π {R}^{2}} = \frac{475 pN}{π \cdot {( 10 nm )}^{2}} = 1.5 MPa$$

The intrinsic NES of the three modalities in exemplary embodiments can hence be estimated to be:

$${NES}_{pre - ANP} = 56 \frac{pN}{\sqrt{Hz}} = 178 \frac{kPa}{\sqrt{Hz}}$$

$${NES}_{ANP} = 73 \frac{pN}{\sqrt{Hz}} = 232 \frac{kPa}{\sqrt{Hz}}$$

$${NES}_{piezo - chrome} = 1.02 \frac{nN}{\sqrt{Hz}} = 3.2 \frac{MPa}{\sqrt{Hz}}$$

### Exemplary Mechanobrightening Through UCNP-to-ANP Transformation

According to various exemplary embodiments of the present disclosure, it is possible determine whether the photon avalanching behavior can be initiated by applied force, resulting in mechanobrightening nanosensors. The systems, methods and sensors according to the exemplary embodiments of the present disclosure can be used for providing non-avalanching UCNPs with Tm³⁺ concentrations just below those sufficient to attain photon-avalanche at ambient conditions, and transforming them into avalanching UCNPs through the utilization of force.

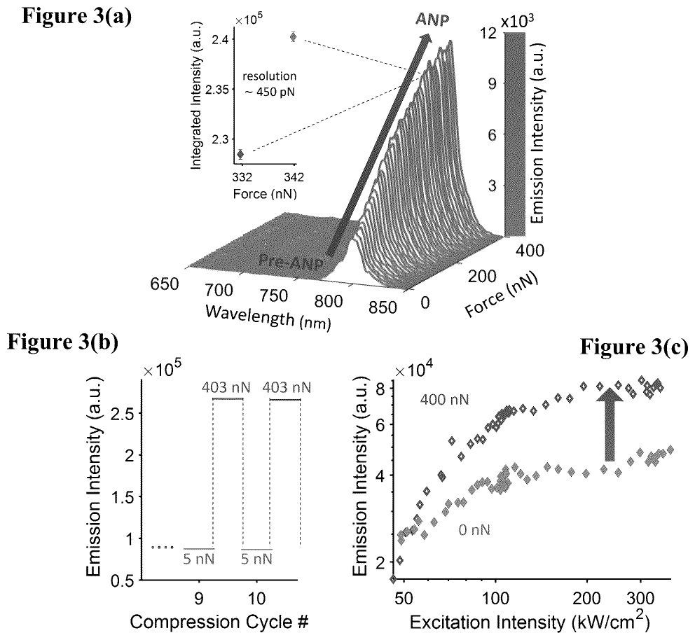

For example, ANPs with 8% Tm³⁺ can indicate a signature photon avalanching response. (See, e.g., Lee, C. et al., 2021.) But for lower concentrations of 1% to 4%, a threshold intensity was less apparent, and the nonlinearities observed in the emission versus excitation curves were much smaller. (See, e.g., Lee, C. et al., 2021.) Exemplary embodiments posit that if the effective Tm³⁺ concentration of a ‘pre-avalanching nanoparticle’—or ‘pre-ANP’ for short—were increased via applied force, one would render the NP avalanching under pressure. Since photon-avalanche is sustained through efficient cross-relaxation (a form of ET) between the emitting lanthanides, (see, e.g., Lee, C. et al., 2021) which is also influenced by phonon-mediated processes, application of force, according to the exemplary embodiments, should enhance this process, and hence transform a pre-ANP into an ANP. Exemplary embodiments, therefore, can utilize a set of particles with Tm³⁺ concentrations ranging from 7% down to 4%, in search of the pre-avalanching concentration. For example, when pressing upon particles with Tm³⁺ concentrations down to 4.5%, the emission decreases with applied force. However, when pressing upon 4% Tm³⁺ particles, the emission intensity increases and is enhanced four-fold for a single force ramp of only ˜400 nN. FIG. 3(a) shows this result by providing a graph of emission spectra as a function of applied force for a single 4% Tm³⁺ pre-ANP. The NP transforms from a pre-ANP at ambient force, to an ANP under 400 nN applied force. The inset in FIG. 3(a) show the integrated intensities from two sequentially measured emission spectra collected during an emission-versus-applied force scan. The noise-defined resolution (as in FIG. 2(d)) is depicted.

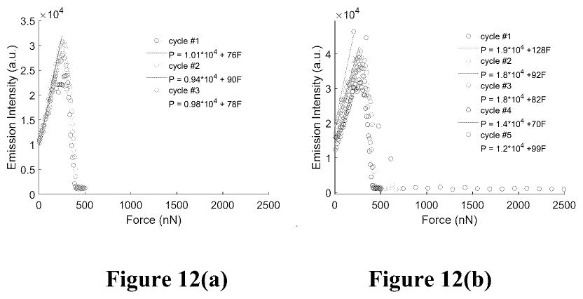

To test the viability of mechanobrightening for force sensing, exemplary embodiments can repeatedly apply forces of 0 to 2.5 μN upon single pre-ANPs, excited at various pump powers. For example, FIGS. 12(a) and 12(b) show graphs of mechano-optical response cyclability of single pre-ANPs. Specifically, FIG. 12(a) shows response from recurring compression cycles on a single pre-ANP excited at 41 kW/cm², while FIG. 12(b) shows response from recurring compression cycles on a single pre-ANP excited at 52 kW/cm². For each cycle, once the particle reaches its maximal emission (at the same force value, within the measurement error), its emission decreases with force following an ANP response to force.

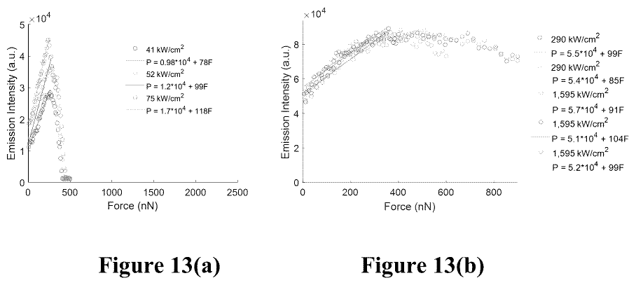

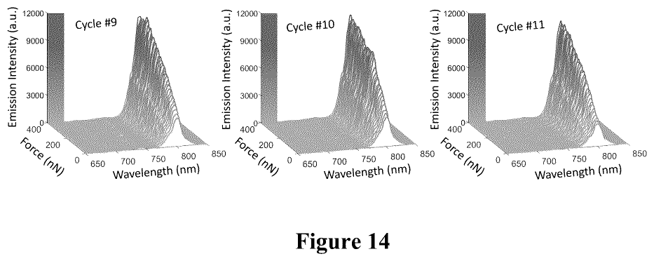

FIGS. 13(a) and 13(b) show graphs of mechano-optical response cyclability of single pre-ANPs, where FIG. 13(a) shows excitation power dependent compression cycles for single pre-ANPs at the low-power regime and FIG. 13(b) shows excitation at the high-power regime. FIG. 14 shows a set of illustrations for repeating pre-ANP to ANP transformations. Specifically shown are the emission increase force range of compression cycles of a pre-ANP measured at ˜1,800 kW/cm².

For example, the transformation into an ANP can occur at ˜400 nN, after which the now-ANP follows conventional ANP response to force—that of emission decrease. This yields a mechanobrightening force range of ˜400 nN for pre-ANPs. According to the exemplary embodiments, the steep increase in emission per unit force facilitates the detection of forces as low as 475 pN within 3 s, as evidenced by the inset in FIG. 3(a), yielding an intrinsic noise-equivalent sensitivity of 56 pN/\sqrt{Hz} for pre-ANPs (See Exemplary Force Resolution and Noise Equivalent Sensitivity (NES) Derivation). According to the exemplary embodiments of the present disclosure, the detection of forces at such high sensitivities, over wide ranges, with an amplifying emission signal, along with the robustness and repeatability of the signal under continuous pumping and force application make pre-ANPs highly attractive for remote mechanical sensing. For example, FIG. 3(b) shows a graph of emission intensity as a function of force for a single pre-ANP after undergoing 8 compression cycles, demonstrating reproducibility.

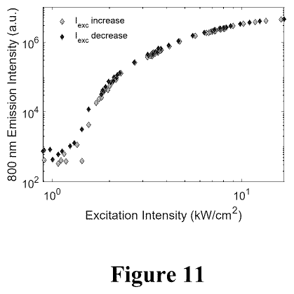

To further understand how force transforms pre-ANPs into ANPs, the systems, methods and sensors according to the exemplary embodiments of the present disclosure can characterize the emission versus excitation profile of a pre-ANP with and without applied force. Unlike ANP excitation-emission curves, which shift to the right upon application of force (see, e.g., FIG. 2(a) and FIG. 1(c)), pre-ANP excitation-emission curves, according to the exemplary embodiments, shift upwards, with increased nonlinearity, manifested in the larger excitation-emission curve slope, as reflected in e.g., FIGS. 3(c) and 1(d). FIG. 3(c) shows a graph of Emission (at 800 nm) versus excitation (at 1064 nm) intensities measured for a single pre-ANP with and without applied force. All error bars represent the (Poisson distribution-) standard deviation of the measured signals. Each full compression cycle consists of 75 force-emission measurements, and lasts 4 min. This distinct change in the excitation-emission profile, observed only for pre-ANPs under applied force, highlights their transition from pre-avalanching to avalanching. With respect to pre-avalanching, FIG. 11 shows a graph of emission intensity versus excitation intensity measured for an ensemble (thin dry film) of pre-ANPs. A maximal slope of ˜8 was found from sectional fitting (minimum number of data points per section: 7) of the log-log data points to a first order polynomial. While this degree of nonlinearity is larger than that found for classical UCNPs undergoing a two-photon upconversion process, it is still lower than that found for avalanching UCNPs, where emission versus excitation log-log plots yield slopes larger than 15. (See, e.g., Qiu, Y., Myers, D. R. & Lam, W. A. 2019).

### Exemplary Mechanochromic Nanosensors

With a goal of expanding utility for a broader range of applications, exemplary embodiments can design mechanochromic nanosensors, with a dual-wavelength ratiometric readout of force. The exemplary aim, according to the exemplary embodiments, is to provide a sensor for which the signal does not depend solely on the intensity of one emission wavelength, but of two emission wavelengths that each show a different force response. According to the exemplary embodiments of the present disclosure, the wavelengths can be be spectrally proximal to enable their simultaneous detection, yet far enough apart so as not to overlap, yielding force-dependent signal that depends on the ratio of these two emissions (the ‘color’ of emission). Mechanochromic self-calibrated signals of this type can provide a built-in control against environmental interference, which can easily disrupt single-wavelength intensity readout. (See, e.g., Park, S.-H, Kwon, N., Lee, J.-H, Yoon, J. & Shin, I., 2020.)

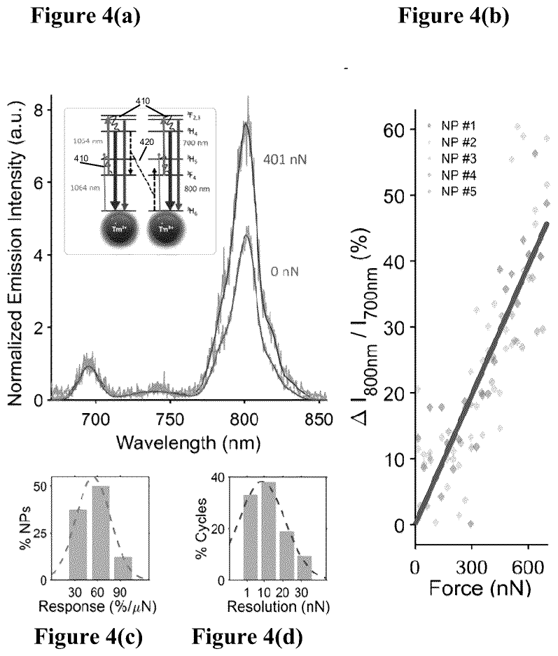

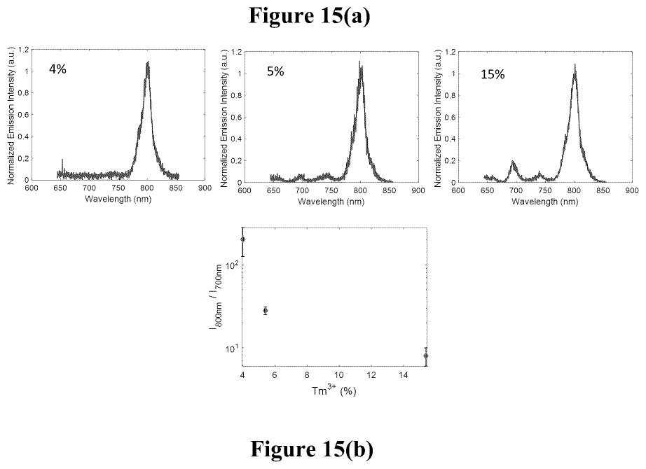

To design mechanochromic nanosensors with substantial emission from both the main photon-avalanche level (³H₄) and a nearby energy level (³F₃), the systems, methods and sensors according to the exemplary embodiments of the present disclosure can increase the Tm³⁺ concentration within the ANPs. As an example, for 15% Tm³⁺, there is sizeable emission at 700 nm (³F₃ level) and 800 nm (³H₄ level), and hereafter refer to 15% Tm³⁺ NPs as ‘piezochromic ANPs’. FIG. 4(a) is a graph showing emission spectra collected from a single 15% Tm³⁺ piezochromic ANP with and without applied force, normalized to the ³F₃ emission intensity. The inset in FIG. 4(a) shows main electronic levels and transitions involved when considering piezochromic dual-wavelength emission. The wavy lines 410 represent multi-phonon relaxation, and the dashed lines 420 represent cross-relaxation. FIGS. 15(a) and 15(b) illustrate 700 nm-emission as a function of Tm³⁺ concentration. Specifically, FIG. 15(a) is a set of graphs for single particle spectra, measured for different Tm³⁺ concentration pre-ANPs/ANPs, at their respective saturation regimes, while FIG. 15(b) is a graph of 800 nm-emission/700 nm-emission ratio versus Tm³⁺ concentration.

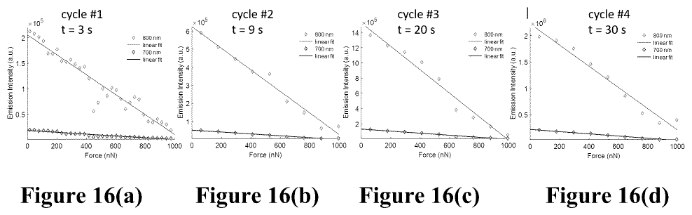

According to the exemplary embodiments of the present disclosure, when subjected to force, the relative emission from the ³H₄ level increases compared to that from the ³F₃ level (see, e.g., FIG. 4(a)), and the overall emission from a piezochromic ANP decreases with force as with the lower-Tm³⁺-content ANPs (see, e.g., FIG. 2). This result is reflected in FIGS. 16(a)-16(d), which provide graphs of single piezochromic ANP compression cycles illustrating 800 nm- and 700 nm-emission intensity versus applied force, for four consecutive force cycles, attained for a single piezochromic ANP. A total of up to 1.5 μN force was applied on the particle at each compression cycle. Each full compression cycle consists of 10-50 force-spectrum data points. Integration time per data point was: 3 s for cycle #1, 9 s for cycle #2, 20 s for cycle #3, and 30 s for cycle #4.

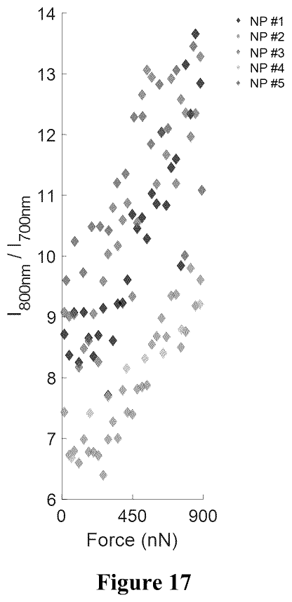

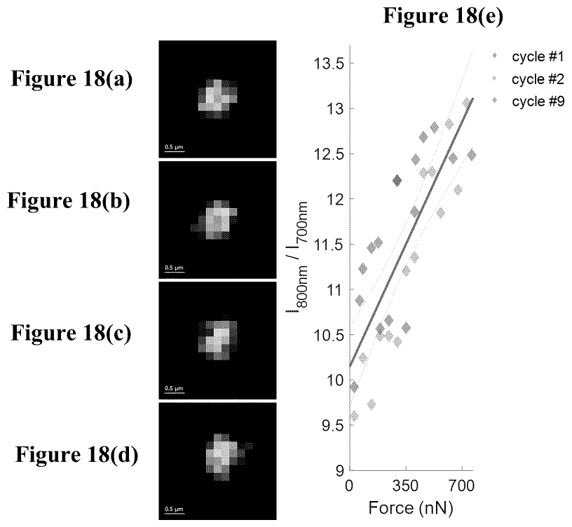

The ratio between these two emission lines, therefore, reports on the applied force. The mechano-optical response, manifested in the percent change of the 800-nm-emission/700-nm-emission ratio per unit force, can be identical for different single NPs probed during different integration times. For example, FIG. 4(b) shows a percent change of the 800 nm-emission/700 nm-emission ratio versus applied force, for five compression cycles originating from five different piezochromic ANPs where the integration times are 3 s (NP #1-#3), 30 s (NP #4), and 50 s (NP #5). (see also FIG. 17, showing that while their initial 800nm-emission/700nm-emission ratios differ by up to ±25%, their mechanical response is similar). The mechano-optical response can be on average 54%/μN. FIG. 4(c) highlights these results, showing mechano-optical response distribution, where response=54±20%/μN; data mean±standard deviation. For each piezochromic ANP according to the exemplary embodiments, the response, ambient-force brightness, and ambient-force dual-emission ratio can remain unchanged under continuous pumping at high excitation intensities and after repeated compression to 2.5 μN. FIGS. 18(a)-18(d) show a set of hyperspectral imaging of a single piezochromic ANP, before compression cycle #1 (FIG. 18(a)), before compression cycle #2 (FIG. 18(b)), and before compression cycle #9 (FIG. 18(c)), as well as after cycle #9 (FIG. 18(d)). FIG. 18(e) shows a graph of 800-nm-emission/700-nm-emission ratio versus applied force, for three force cycles, attained for a single piezochromic ANP (pre- and post-imaging shown in FIGS. 18(a)-18(d)). A total of 1 μN force can be applied on the particle at each compression cycle. Each full compression cycle can consist of 10-20 force-spectrum data points. Integration time per data point can be: 30 s (cycle #1), 50 s (cycle #2), and 3 s (cycle #9).

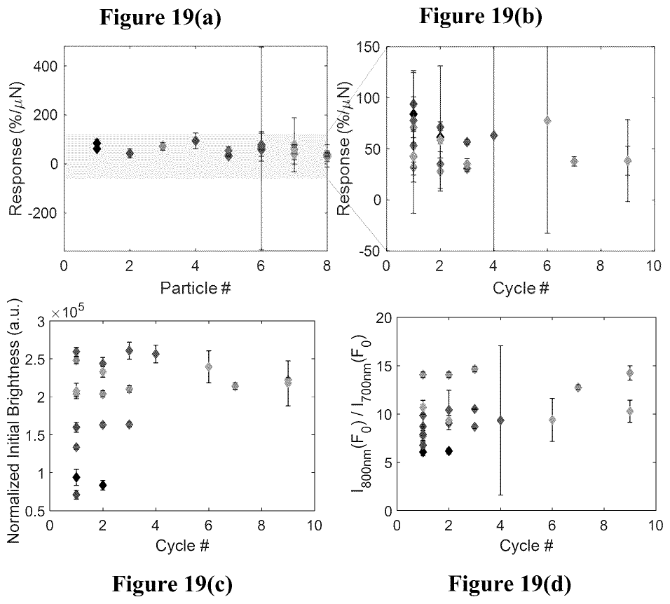

FIGS. 19(a)-19(d) show mechano-optical response versus cycle # for single piezochromic ANPs. Specifically, FIG. 19(a) shows a graph of a mechano-optical response (percent change of the 800 nm-emission/700 nm-emission ratio versus applied force), for up to nine compression cycles per particle, for eight different piezochromic ANPs. FIG. 19(b) shows mechano-optical response for the ANPs, FIG. 19(c) shows normalized initial brightness, and FIG. 19(d) shows initial 800 nm-emission/700 nm-emission ratio. Data is derived from 21 compression cycles on eight piezochromic ANPs. Each compression cycle consists of 10-1000 emission versus force data points. Error bars depict the extrapolated errors derived from the 800 nm-emission/700 nm-emission ratio versus applied force fit values' 95% confidence intervals. Data points in c can be normalized to a 3 s integration time baseline (i.e., divided by their respective integration times, and multiplied by 3s), so as to conform to data acquired for the other (pre-avalanching and avalanching) particles—for comparison between particles (data in c can be further normalized to a 1 s integration time baseline for NES derivation).

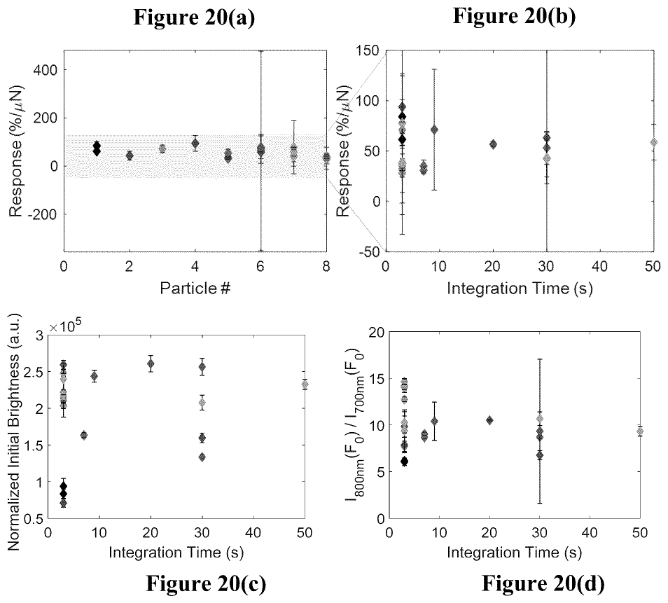

FIGS. 20(a)-20(d) show mechano-optical response versus integration time for single piezochromic ANPs, Specifically, FIG. 20(a) shows a graph of a mechano-optical response (percent change of the 800 nm-emission/700 nm-emission ratio versus applied force), for up to nine compression cycles per particle, for eight different piezochromic ANPs. FIG. 20(b) shows mechano-optical response for the ANPs, FIG. 20(c) shows normalized initial brightness, and FIG. 20(d) shows initial 800 nm-emission/700 nm-emission ratio versus integration time. Data is derived from 21 compression cycles on eight piezochromic ANPs. Each compression cycle can consist of 10-1000 emission versus force data points. Error bars depict the extrapolated errors derived from the 800 nm-emission/700 nm-emission ratio versus applied force fit values' 95% confidence intervals. Data points in c can be normalized to a 3 s integration time baseline (i.e., divided by their respective integration times, and multiplied by 3s), so as to conform to data acquired for the other (pre-avalanching and avalanching) particles—for comparison between particles (data shown in FIG. 20(c) was further normalized to a 1 s integration time baseline for NES derivation).

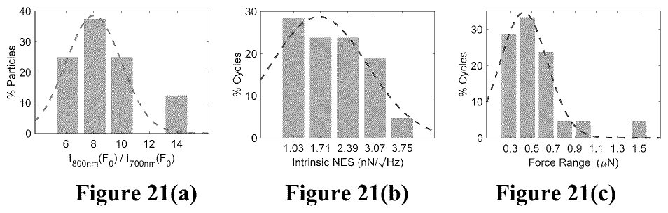

In various exemplary embodiments of the present disclosure, the large mechano-optical response and ambient-force brightness, together with the low ambient-force dual-emission ratio found for piezochromic ANPs (as reflected in FIGS. 19-21) can facilitate the detection of single-digit nN forces within less than 1 min, and yield an intrinsic noise-equivalent sensitivity of 1.02 nN/\sqrt{Hz}. For example, FIG. 4(d) shows a force resolution distribution where resolution=13±9 nN; data mean±standard deviation. FIG. 21(a) shows initial 800 nm-emission/700 nm-emission ratio, FIG. 21(b) shows intrinsic NES, and FIG. 21(c) shows force range population distributions, along with their Gaussian fits, for 21 compression cycles measured for eight piezochromic ANPs. Each compression cycle consists of 10-1000 emission versus force data points, measured at different integration times (3-50 s). The normal distribution fits yield averages and standard deviations of: I₈₀₀ₙₘ/I₇₀₀ₙₘ (F=0)=8±2 (see intrinsic NES=1.7±1.2 nN/\sqrt{Hz} (see F_{range}=0.4±0.2 μN). (See Exemplary Force Resolution and Noise Equivalent Sensitivity (NES) Derivation).

### Exemplary Discussion

According to various exemplary embodiments of the present disclosure, the steep nonlinearity of the photon-avalanche process can facilitate the amplification of subtle interionic distance changes through numerous cycles of cross-relaxation, each of which scales inversely with distance to the sixth power and/or exponentially if Dexter ET is present. This, in addition to the high intrinsic quantum yield of ANPs, (see, e.g., Lee, C. et al., 2021) enables exemplary embodiments to detect three orders of magnitude of force at any pump intensity utilized. Overall, for example, four or more orders of magnitude of force can be probed with the same single ANP by simply adjusting the pump intensity-allowing for remote multiple-scale force sensing of nanoscale environments.

According to the exemplary embodiments of the present disclosure, the ability to transform a conventional UCNP into an ANP and back through the application and release of force, respectively, further highlights the strong dependence of the photon-avalanche mechanism on interionic distance and phonon energy. For example, only 400 nN of force may be required to observe four-fold emission increase at ambient conditions. Although emission intensity increase with pressure has been shown in previous hydrostatic pressure studies of lanthanide-doped UCNPs, (see, e.g., Wisser, M. D. et al., 2015; and Runowski, M. et al., 2017) an enhancement of 1.7× with the systems, methods and sensors according to the exemplary embodiments of the present disclosure was observed at most, using orders of magnitude larger forces. Those changes in signal can be due to modifications of the crystal field symmetry, as the NPs used were of cubic-phase, and hence centro-symmetric in nature.

Compression of hexagonal-phase NPs according to various exemplary embodiments of the present disclosure, did not yield measurable increase in signal with pressure. Because the pre-ANPs used are hexagonal-phase NPs, the observed changes can rely more on interionic distance than on crystal field symmetry. As the interionic distance and phonon energy govern the degree of cross-relaxation between emitters—the main factor in photon avalanching—minute changes in the former will lead to substantial changes in signal intensity. These observations have led to the design of the systems, methods and sensors according to the exemplary embodiments of the present disclosure including mechanobrightening pre-ANPs, which can be configured to detect a wide range of forces, from 475 pN to 400 nN.

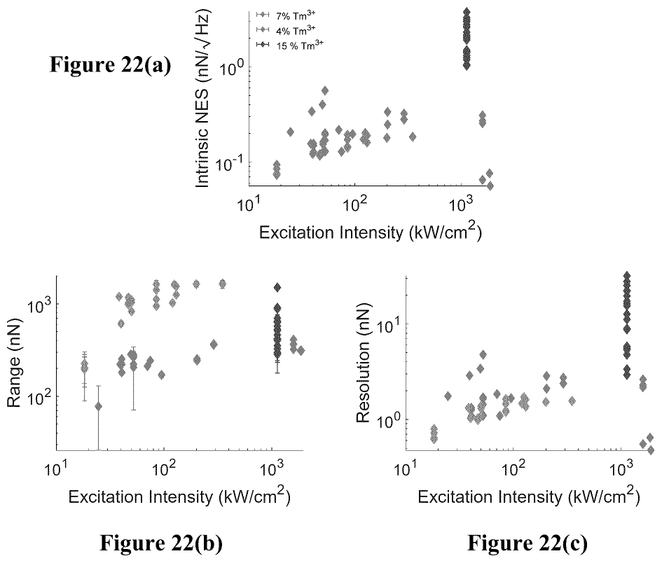

The piezochromic ANPs according to the exemplary embodiments of the present disclosure offer force sensitivities an order of magnitude higher than the state of the art nanoscale ratiometric force sensors at ambient conditions. (See, e.g., Casar, J. R., McLellan, C. A., Siefe, C. & Dionne, J. A., 2020; and McLellan, C.A. et al., 2022.) Yet pN-scale forces, easily detectable with pre-ANPs and ANPs, were not detected with piezochromic ANPs with the same experimental conditions. For example, FIGS. 22(a)-22(c) show ANP, pre-ANP, and piezochromic ANP mechano-optical parameters versus excitation intensity, where FIG. 22(a) shows Intrinsic NES, FIG. 22(b) shows force range, and FIG. 22(c) shows resolution. The figures show results derived from 26 compression cycles on four 4% Tm³⁺ pre-ANPs, 23 compression cycles on seven 7% Tm³⁺ ANPs, and 21 compression cycles on eight 15% Tm³⁺ piezochromic ANPs. Each compression cycle consists of 10-1000 emission vs. force data points, measured at 3 s (4% Tm³⁺), 3 s (7% Tm³⁺), and 3-50 s (15% Tm³⁺) integration times. Error bars are derived from the fit values' 95% confidence intervals.

This can be due to a different underlying mechanism behind the mechanochromism ratiometric change: While the record sensitivities of pre-ANPs and ANPs are highly dependent on the emitter-emitter interionic distance and photon-avalanche magnification, the sensitivity of piezochromic ANPs is mainly dependent on intra-ion energy relaxation, which depends more on the overall interionic distance of the host lattice ions. (See, e.g., van Sweiten, T. P. et al., 2022.) Once the latter is decreased by application of force, the vibrational energy of the host lattice, and therefore the nonradiative relaxation rate between the ³F₃ level and the ³H₄ level, is increased, as seen in previous studies of lanthanide-doped NaYF₄. (See, e.g., Wisser, M. D. et al., 2015; Lage, M. M., Moreira, R. L., Matinaga, F. M. & Gesland, J.-Y, 2005; and Dong, H., Sun, L.-D. & Yan, C.-H, 2021.)

Thus, by leveraging the high nonlinearity offered by photon-avalanche, exemplary embodiments are able to offer nanoscale, remotely controlled, NIR-input, NIR-output, high dynamic range, force sensors with force sensitivities falling within the previously inaccessible force range of all existing optical nanosensors. (See, e.g., Mehlenbacher, R. D., Kolbl, R., Lay, A. & Dionne, J. A., 2017; and Casar, J. R., McLellan, C. A., Siefe, C. & Dionne, J. A., 2020.) Different modalities of readout (from mechanobrightening to mechanochromism), with different force resolutions (from pNs to nNs), can be utilized by choice of nanosensor Tm³⁺ concentration. The ability to remotely and accurately quantify local forces on these multiple scales will enable advances in both fundamental investigations and critical applications, allowing discovery and precision review of local mechano-induced processes and, ultimately, their quantification, nano-mapping of spatial distributions, and early detection of malfunction, in technological devices and physiology.

TABLE 1
Mean core axes lengths and core + shell axes lengths,
calculated from TEM measurements (see, e.g., FIGS. 5(a) and
5(b)), for the particles investigated in this review. Length
errors are one standard deviation from the mean. Shell thickness
errors are propagated from all the length errors for each particle
respectively. Tm³⁺ concentrations are derived from the
ICP elemental analysis of the cores.

| Tm³⁺ | | | Core + | Core + | Average |
|---|---|---|---|---|---|
| Concen- | Core | Core | Shell | Shell | shell |
| tration | minor axis | major axis | minor axis | major axis | thickness |
| (mol %) | (nm) | (nm) | (nm) | (nm) | (nm) |
| 3.99 | 27.9 ± 1.5 | 35.3 ± 1.5 | 40.7 ± 2.2 | 45.2 ± 2.4 | 5.7 ± 1.9 |
| 4.56 | 20.7 ± 1.0 | 32.5 ± 1.8 | 36.1 ± 1.8 | 38.9 ± 2.0 | 5.5 ± 1.6 |
| 6.95 | 14.4 ± 1.3 | 17.5 ± 1.4 | 29.8 ± 4.9 | 36.5 ± 2.9 | 8.5 ± 1.9 |
| 15.42 | 18.6 ± 0.9 | 22.5 ± 1.3 | 39.1 ± 1.5 | 38.1 ± 1.5 | 9.1 ± 1.3 |

TABLE 2
Derived Tm³⁺ dopant concentrations, phonon-assisted non-radiative
relaxation rates, and maximum nonlinearity factors, from fitting
the data in FIG. 2(a) to the photon avalanche differential rate
equations developed in ref (see, e.g., Lee, C., Xu, E. Z., Liu,
Y., Teitelboim, A., Yao, K., Fernandez-Bravo, A., Kotulska, A.
M., Nam, S. H., Suh, Y. D., Bednarkiewicz, A., 2021).

| | | W₂^{NR} (s⁻¹) | Maximum |
|---|---|---|---|
| | Tm³⁺ | (multi-phonon | nonlinearity |
| | Concentration | relaxation rate | factor s |
| Parameter | (mol %) | from ³F₄ to ³H₆) | (Iₒᵤₜ = Iᵢₙ^{s}) |
| F = 0 | 4.67 ± 0.08 | 6.7 ± 3.4 | 53.3 |
| F = 200 nN | 4.67 ± 0.13 | 58.6 ± 8.7 | 40.8 |

### Exemplary Materials and Methods

### Exemplary Materials

Sodium trifluoroacetate (98%), Gadolinium (III) chloride (GdCl₃, 99.9+%), Thulium (III) chloride (TmCl₃, 99.9+%), Yttrium (III) chloride (YCl₃, 99.9+%), ammonium fluoride (NH₄F, 99.9%), oleic acid (OA, 90%), octadecene (ODE, technical grade, 90%), and hexane (anhydrous, 99.5%) were purchased from Sigma-Aldrich. Sodium oleate (>97%) was purchased from TCI. All chemicals were used without any further purification.

### Exemplary Core Synthesis

NaYF₄: Tm³⁺ core nanoparticles were synthesized using a previously described synthesis, with some modification. (See, e.g., Ostrowski, A. D., Chan, E. M., Gargas, D. J., Katz, E. M., Han, G., Schuck, P. J., Milliron, D. J., Cohen, B. E., 2012.) NaYF₄: 4% Tm³⁺ cores were synthesized as described further, and cores with other Tm³⁺ doping amounts were prepared analogously by varying the stoichiometric amounts of YCl₃ and TmCl₃. YCl₃ (0.96 mmol, 187.5 mg) and TmCl₃ (0.04 mmol, 11.0 mg) were added together with OA (6 mL) and ODE (18 mL) to a dry 50 mL 3-neck round bottom flask. The flask was stirred, placed under a vacuum, and heated to 100° C. for 1 hour, causing the solution to become clear. The flask was then filled with N₂, and sodium oleate (2.5 mmol, 761.1 mg) and NH₄F (4 mmol, 148.1 mg) were added. The flask was subsequently placed under vacuum and stirred for another 20 min, followed by N₂ flushing (×3). The reaction was heated to 320° C. and allowed to react under N₂. After 60 min of reaction time, the flask was rapidly cooled down to room temperature by a strong stream of air, and nanoparticles were isolated with the help of ethanol (20 mL) and centrifugation (3000 rpm, 5 min). The nanoparticles were additionally washed with hexane:ethanol (1:1 v/v) twice and redispersed in 4 mL of hexane for storage.

### Exemplary Preparation of Shell Precursors

Epitaxial NaYF₄: 20% Gd³⁺ shells were grown on the doped NaYF_{4:} Tm³⁺ cores in a nitrogen-filled glove box with laboratory automation robot Workstation for Automated Nanocrystal Discovery and Analysis (WANDA). (See, e.g., Chan, E. M., Xu, C., Mao, A. W., Han, G., Owen, J. S., Cohen, B. E., Milliron, D. J., 2010.) Precursor solution, corresponding to the composition of the epitaxially grown shell layer, was prepared by heating stoichiometric amounts of lanthanide chlorides (LnCl₃, 2.5 mmol of total amount) to 110° C. in OA (10 mL) and ODE (15 mL), and stirred for 15 min under vacuum. The flask was filled with N₂ and heated to 160° C. for 30 min to allow the LnCl₃ to dissolve, which was followed by another 15 min at 110° C. under vacuum, rendering a 0.1 M solution of stoichiometric mixture of lanthanide oleates. In a separate flask, a Na and F precursor was prepared by dissolving sodium trifluoroacetate (8 mmol, 1088 mg) in OA (20 mL) and ODE (20 mL) and applying vacuum at room temperature for 60 min, resulting in a 0.2 M sodium trifluoroacetate oleate solution (Na-TFA-OA).

### Exemplary Synthesis of Core/shell NaYF4: Tm3+/NaYF4: 20% Gd3+ Nanoparticles

NaYF4: 20% Gd³⁺ shells of 5-9 nm thickness were grown on the core nanoparticles using a layer-by-layer protocol similar to that used in Levy et al. (See, e.g., Levy, E. S., Tajon, C. A., Bischof, T. S., Iafrati, J., Fernandez-Bravo, A., Garfield, D. J., Chamanzar, M., Maharbiz, M. M., Sohal, V. S., Schuck, P. J., 2016.) Briefly, for a shell thickness of 6 nm, 6 ml ODE and 4 ml OA were added to the dried cores and heated to 280° C. at 20° C. min⁻¹ in the WANDA glove box. The automated protocol alternated between injections of a 0.2 M Na-TFA-OA stock solution and a 0.1 M stock solution of 20% gadolinium and 80% yttrium oleate solution. One injection was performed every 20 min for a total of 32 injections (16 injections for each precursor). Following the last injection, each reaction was annealed at 280° C. for an additional 30 min and then cooled rapidly by nitrogen flow. The particles were isolated and purified according to the purification protocol described for the cores.

### Exemplary Structural characterization

The TEM images were obtained by transmission electron microscope (JEOL 2100F) with an accelerating voltage of 200 kV. Powder X-ray diffraction (XRD) patterns were acquired with a Bruker AXS D8 Discover GADDS X-ray diffractometer, using Co Kα radiation. The Tm³⁺ doping concentration in the cores was measured by elemental analysis using inductively coupled plasma (ICP) optical emission spectroscopy (measurements performed by Galbraith Laboratories, Inc.).

### Exemplary Single-Particle Sample Preparation

˜40 μl of 0.02-0.1 nM particle suspension in hexane were spin-coated at 1-3 krpm for 1 min upon sterilized poly-L-lysine-coated 170-μm-thick glass coverslips (Electron Microscopy Sciences 72292-20). Prepared single-particles-on-glass samples were stored at ambient conditions prior to AFM and optical measurements. Single-particle dispersity (˜2 μm between particles) of the sample was verified by AFM scanning and optical scanning of the sample.

### Exemplary Mechano-Optical Configuration

All measurements were carried out with a custom-designed combined AFM atop an inverted optical microscope, based on a Horiba Trios system, operating in ambient conditions. Modifications were made in order to accommodate usage of thin, transparent samples and high N.A. oil immersive objectives without experiencing mechanical vibrations. Elimination of acoustic noise included the design of screw-in, small (D˜4 mm) aperture, sample holders, and an acoustic-foam-lined isolation chamber. Reduction of structural vibrations was attained by high-mass support for the microscope base, a heavy base for the microscope objective, and sorbothane isolation of the microscope breadboard.

### Exemplary Mechano-Optical Measurements

After the location of a single particle and verification of a single, rather than clustered, entity by ensuring its brightness was lower than the cutoff maximal brightness expected for a single particle at the corresponding excitation intensity or by AFM scanning at high resolution, its power dependent emission was characterized at ambient conditions. For power-dependent measurements, a gradient neutral density (ND) wheel was rotated by a computer-driven program; excitation powers were measured by diverting ˜10% of the excitation power exiting the ND wheel to a power meter by a thin glass slide placed at an angle to the excitation path axis. Excitation intensities were calculated using measured excitation powers and dividing by the area calculated from the image of the focused laser spot. Excitation of the sample and collection of its emission were both through a 60×, 1.4 N.A., oil objective (Nikon CFI Plan Apochromat Lambda) located beneath the sample. Excitation of the particles was carried out with a continuous-wave 1064 nm laser diode (QPhotonics), after filtration with 900 nm long-pass (LP) and 950 nm LP filters. Emission from the particles was filtered with 850 nm short-pass (SP), 945 nm SP, and 950 nm SP filters, before it was measured by the LabRAM spectrometer Synapse EM-CCD.

Silicon AFM force-modulation probes with spring constants of 0.8-8.9 N/m and resonance frequencies of 36-98 kHz (ACCESS-FM Probes, Applied Nanostructures) were utilized for tapping mode scanning and for force application. Tip radius of curvature according to the specifications was 6 nm; application of 2.5 μN force (the maximum force applied in this review) increased tip bluntness and radius of curvature, as the force magnitude was larger than silicon's plastic deformation threshold. Application of force upon a particle was gradual, so as to prevent particle displacement. Optical scanning of the particle before and after compression cycles was carried out to ensure no sample drift or particle displacement occurred due to force application; inconsistency between these scans rendered the data acquired in between discardable.

### Exemplary Data Analysis

Decompression cycles were not analyzed, as all the measurements were carried out at ambient conditions, where the adhesion force arising from the condensed meniscus upon the tip and particle (see, e.g., Wallace, A., 2019; and Ziao, C., Shi, P., Yan, W., Chen, L., Qian, L., Kim, S. H., 2019), opposes tip retraction. The 800 nm- and the 700 nm-emission were calculated as the 760 nm<λ<840 nm and the 675 nm<λ<720 nm integrated intensity, respectively. Each particle was compressed several times at each excitation intensity. For the pre-ANPs and the ANPs, each compression cycle 800-nm-emission versus force dataset was fitted to a linear polynomial of the form P=aF+b, where b=I₀t and a=I₀tR (See Exemplary Force Resolution and Noise Equivalent Sensitivity (NES) Derivation). The particle response R, as well as the force resolution

$$( \frac{1}{\vert R \vert \sqrt{{I}_{0} t}} ) ,$$

were derived from the fit a and b values. The accessible force range was derived from the fit F value at P=0 for the ANPs; the force range for the pre-ANPs was that yielding the fit with the maximal positive slope.

For the piezochromic ANPs, each compression cycle 800 -nm-emission/700 -nm-emission ratio versus force dataset was fitted to a linear polynomial of the form α=aF+b, where b=α₀ and a=α₀R (See Exemplary Force Resolution and Noise Equivalent Sensitivity (NES) Derivation). The particle response R, as well as the force resolution

$$( \frac{1 + {α}_{0}}{\vert R \vert \sqrt{{I}_{0} t {α}_{0}}} ) ,$$

were derived from the fit a and b values. The accessible force range was determined by the 700-nm-emission signal to noise ratio (SNR); i.e., when SNR˜1. The NES was derived from multiplication of the force resolution by the square root of the measurement integration time. Errors on each of the values were extrapolated from the errors on the fit values (Δa and Δb, which are the half-widths of the fitted values' 95% confidence intervals).

According to the exemplary embodiments of the present disclosure, numerous specific details have been set forth. It is to be understood, however, that implementations of the disclosed technology can be practiced without these specific details. In other instances, well-known methods, structures and techniques have not been shown in detail in order not to obscure an understanding of this description. References to “some examples,” “other examples,” “one example,” “an example,” “various examples,” “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrases “in one example,” “in one exemplary embodiment,” or “in one implementation” does not necessarily refer to the same example, exemplary embodiment, or implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification and drawings, can be used synonymously in certain instances, including, but not limited to, for example, data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

Throughout the disclosure, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

This written description uses examples to disclose certain implementations of the disclosed technology, including the best mode, and also to enable any person skilled in the art to practice certain implementations of the disclosed technology, including making and using any devices or systems and performing any incorporated methods.

### EXEMPLARY REFERENCES

The following references are hereby incorporated by reference, in their entireties:
1 Gouveia, B. et al. Capillary forces generated by biomolecular condensates. Nature 609, 255-264 (2022).
2 Ucar, H. et al. Mechanical actions of dendritic-spine enlargement on presynaptic exocytosis. Nature 600, 686-689 (2021).
3 Handler, A. & Ginty, D. D. The mechanosensory neurons of touch and their mechanisms of activation. Nature Reviews Neuroscience 22, 521-537 (2021).
4 Qiu, X. & Müller, U. Sensing sound: Cellular specializations and molecular force sensors. Neuron (2022).
5 Marshall, K. & Patapoutian, A. Getting a grip on touch receptors. Science 368, 1311-1312 (2020).
6 Vining, K. H. & Mooney, D. J. Mechanical forces direct stem cell behaviour in development and regeneration. Nature reviews Molecular cell biology 18, 728-742 (2017).
7 Nonomura, K. et al. Piezo2 senses airway stretch and mediates lung inflation-induced apnoea. Nature 541, 176-181 (2017).
8 Murthy, S. E., Dubin, A. E. & Patapoutian, A. Piezos thrive under pressure: mechanically activated ion channels in health and disease. Nature reviews Molecular cell biology 18, 771-783 (2017).
9 Lam, R. M. et al. PIEZO2 and perineal mechanosensation are essential for sexual function. Science 381, 906-910 (2023).
10 Hill, R. Z., Loud, M. C., Dubin, A. E., Peet, B. & Patapoutian, A. PIEZO1 transduces mechanical itch in mice. Nature 607, 104-110 (2022).
11 Marshall, K. L. et al. PIEZO2 in sensory neurons and urothelial cells coordinates urination. Nature 588, 290-295 (2020).
12 Zeng, W.-Z. et al. PIEZOs mediate neuronal sensing of blood pressure and the baroreceptor reflex. Science 362, 464-467 (2018).
13 Li, M., Pal, A., Aghakhani, A., Pena-Francesch, A. & Sitti, M. Soft actuators for real-world applications. Nature Reviews Materials 7, 235-249 (2022).
14 Romani, P., Valcarcel-Jimenez, L., Frezza, C. & Dupont, S. Crosstalk between mechanotransduction and metabolism. Nature Reviews Molecular Cell Biology 22, 22-38 (2021).
15 Saraswathibhatla, A., Indana, D. & Chaudhuri, O. Cell-extracellular matrix mechanotransduction in 3D. Nature Reviews Molecular Cell Biology, 1-22 (2023).
16 Gómez-González, M., Latorre, E., Arroyo, M. & Trepat, X. Measuring mechanical stress in living tissues. Nature Reviews Physics 2, 300-317 (2020).
17 Jain, S. et al. The role of single-cell mechanical behaviour and polarity in driving collective cell migration. Nature physics 16, 802-809 (2020).
18 De Belly, H., Paluch, E. K. & Chalut, K. J. Interplay between mechanics and signalling in regulating cell fate. Nature Reviews Molecular Cell Biology 23, 465-480 (2022).
19 Qiu, Y., Myers, D. R. & Lam, W. A. The biophysics and mechanics of blood from a materials perspective. Nature Reviews Materials 4, 294-311 (2019).
20 Killeen, A., Bertrand, T. & Lee, C. F. Polar fluctuations lead to extensile nematic behavior in confluent tissues. Physical Review Letters 128, 078001 (2022).
21 de Vasconcelos, L. S. et al. Chemomechanics of Rechargeable Batteries: Status, Theories, and Perspectives. Chemical Reviews 122, 13043-13107, doi: 10.1021/acs.chemrev.2c00002 (2022).
22 Huang, W. et al. Onboard early detection and mitigation of lithium plating in fast-charging batteries. Nature Communications 13, 7091, doi: 10.1038/s41467-022-33486-4 (2022).
23 Liu, K., Liu, Y., Lin, D., Pei, A. & Cui, Y. Materials for lithium-ion battery safety. Science Advances 4, eaas9820, doi: doi: 10.1126/sciadv.aas9820 (2018).
24 Doux, J. M. et al. Stack pressure considerations for room-temperature all-solid-state lithium metal batteries. Advanced Energy Materials 10, 1903253 (2020).
25 Kaushik, S. & Persson, A. I. Unlocking the dangers of a stiffening brain. Neuron 100, 763-765 (2018).
26 Chen, X. et al. A feedforward mechanism mediated by mechanosensitive ion channel PIEZO1 and tissue mechanics promotes glioma aggression. Neuron 100, 799-815. e797 (2018).
27 Zhang, J. & Reinhart-King, C. A. Targeting tissue stiffness in metastasis: mechanomedicine improves cancer therapy. Cancer Cell 37, 754-755 (2020).
28 Nickels, P. C. et al. Molecular force spectroscopy with a DNA origami-based nanoscopic force clamp. Science 354, 305-307 (2016).
29 Ringer, P. et al. Multiplexing molecular tension sensors reveals piconewton force gradient across talin-1. Nature methods 14, 1090-1096 (2017).
30 Stabley, D. R., Jurchenko, C., Marshall, S. S. & Salaita, K. S. Visualizing mechanical tension across membrane receptors with a fluorescent sensor. Nature methods 9, 64-67 (2012).
31 Brockman, J. M. et al. Live-cell super-resolved PAINT imaging of piconewton cellular traction forces. Nature methods 17, 1018-1024 (2020).
32 Blanchard, A. T. & Salaita, K. Emerging uses of DNA mechanical devices. Science 365, 1080-1081 (2019).
33 Campàs, O. et al. Quantifying cell-generated mechanical forces within living embryonic tissues. Nature methods 11, 183-189 (2014).
34 Serwane, F. et al. In vivo quantification of spatially varying mechanical properties in developing tissues. Nature methods 14, 181-186 (2017).
35 Mehlenbacher, R. D., Kolbl, R., Lay, A. & Dionne, J. A. Nanomaterials for in vivo imaging of mechanical forces and electrical fields. Nature Reviews Materials 3, 1-17 (2017).
36 Sun, W., Gao, X., Lei, H., Wang, W. & Cao, Y. Biophysical approaches for applying and measuring biological forces. Advanced Science 9, 2105254 (2022).
37 Lee, C. et al. Giant nonlinear optical responses from photon-avalanching nanoparticles. Nature 589, 230-235 (2021).
38 Boocock, D., Hino, N., Ruzickova, N., Hirashima, T. & Hannezo, E. Theory of mechanochemical patterning and optimal migration in cell monolayers. Nature physics 17, 267-274 (2021).
39 Miroshnikova, Y. A. et al. Adhesion forces and cortical tension couple cell proliferation and differentiation to drive epidermal stratification. Nature cell biology 20, 69-80 (2018).
40 Petridou, N. I., Spiró, Z. & Heisenberg, C.-P. Multiscale force sensing in development. Nature cell biology 19, 581-588 (2017).
41 Van Helvert, S., Storm, C. & Friedl, P. Mechanoreciprocity in cell migration. Nature cell biology 20, 8-20 (2018).
42 Liu, C. et al. Heterogeneous microenvironmental stiffness regulates pro-metastatic functions of breast cancer cells. Acta Biomaterialia 131, 326-340 (2021).
43 Midolo, L., Schliesser, A. & Fiore, A. Nano-opto-electro-mechanical systems. Nature nanotechnology 13, 11-18 (2018).
44 Tsoukalas, K., Lahijani, B. V. & Stobbe, S. Impact of transduction scaling laws on nanoelectromechanical systems. Physical Review Letters 124, 223902 (2020).
45 Polacheck, W. J. & Chen, C. S. Measuring cell-generated forces: a guide to the available tools. Nature methods 13, 415-423 (2016).
46 Wu, J., Lewis, A. H. & Grandl, J. Touch, tension, and transduction-the function and regulation of Piezo ion channels. Trends in biochemical sciences 42, 57-71 (2017).
47 Bednarkiewicz, A., Chan, E. M., Kotulska, A., Marciniak, L. & Prorok, K. Photon avalanche in lanthanide doped nanoparticles for biomedical applications: super-resolution imaging. Nanoscale Horizons 4, 881-889 (2019).
48 Dudek, M. et al. Size-Dependent Photon Avalanching in Tm3+ Doped LiYF4 Nano, Micro, and Bulk Crystals. Advanced Optical Materials 10, 2201052 (2022).
49 Skripka, A. et al. A Generalized Approach to Photon Avalanche Upconversion in Luminescent Nanocrystals. Nano Letters 23, 7100-7106, doi: 10.1021/acs.nanolett.3c01955 (2023).
50 Liang, Y. et al. Migrating photon avalanche in different emitters at the nanoscale enables 46th-order optical nonlinearity. Nature Nanotechnology 17, 524-530 (2022).
51 Zhang, Z. et al. Tuning phonon energies in lanthanide-doped potassium lead halide nanocrystals for enhanced nonlinearity and upconversion. Angewandte Chemie International Edition 62, e202212549 (2023).
52 Wu, S. et al. Non-blinking and photostable upconverted luminescence from single lanthanide-doped nanocrystals. Proceedings of the National Academy of Sciences 106, 10917-10921 (2009).
53 Park, Y. I. et al. Nonblinking and nonbleaching upconverting nanoparticles as an optical imaging nanoprobe and T1 magnetic resonance imaging contrast agent. Advanced Materials 21, 4467-4471 (2009).
54 Cohen, B. E. Beyond fluorescence. Nature 467, 407-408 (2010).
55 Ostrowski, A. D. et al. Controlled synthesis and single-particle imaging of bright, sub-10 nm lanthanide-doped upconverting nanocrystals. ACS nano 6, 2686-2692 (2012).
56 Gargas, D. J. et al. Engineering bright sub-10-nm upconverting nanocrystals for single-molecule imaging. Nature nanotechnology 9, 300-305 (2014).
57 Lee, C. et al. Indefinite and bidirectional near-infrared nanocrystal photoswitching. Nature 618, 951-958 (2023).
58 Fischer, S., Bronstein, N. D., Swabeck, J. K., Chan, E. M. & Alivisatos, A. P. Precise tuning of surface quenching for luminescence enhancement in core-shell lanthanide-doped nanocrystals. Nano letters 16, 7241-7247 (2016).
59 Johnson, N. J. et al. Direct evidence for coupled surface and concentration quenching dynamics in lanthanide-doped nanocrystals. Journal of the American Chemical Society 139, 3275-3282 (2017).
60 Casar, J. R., McLellan, C. A., Siefe, C. & Dionne, J. A. Lanthanide-based nanosensors: refining nanoparticle responsiveness for single particle imaging of stimuli. ACS photonics 8, 3-17 (2020).
61 Sinatra, N. R. et al. Ultragentle manipulation of delicate structures using a soft robotic gripper. Science Robotics 4, eaax5425 (2019).
62 Trepat, X. et al. Physical forces during collective cell migration. Nature physics 5, 426-430 (2009).
63 Huber, M., Casares-Arias, J., Fässler, R., Müller, D. J. & Strohmeyer, N. In mitosis integrins reduce adhesion to extracellular matrix and strengthen adhesion to adjacent cells. Nature Communications 14, 2143 (2023).
64 Fletcher, D. A. & Mullins, R. D. Cell mechanics and the cytoskeleton. Nature 463, 485-492 (2010).
65 Feld, L. et al. Cellular contractile forces are nonmechanosensitive. Science advances 6, eaaz6997 (2020).
66 Liu, Z. et al. Nanoscale optomechanical actuators for controlling mechanotransduction in living cells. Nature methods 13, 143-146 (2016).
67 Van den Heuvel, M. G. & Dekker, C. Motor proteins at work for nanotechnology. Science 317, 333-336 (2007).
68 Wisser, M. D. et al. Strain-induced modification of optical selection rules in lanthanide-based upconverting nanoparticles. Nano letters 15, 1891-1897 (2015).
69 Lage, M. M., Moreira, R. L., Matinaga, F. M. & Gesland, J.-Y. Raman and infrared reflectivity determination of phonon modes and crystal structure of Czochralski-grown NaLnF4 (Ln=La, Ce, Pr, Sm, Eu, and Gd) single crystals. Chemistry of materials 17, 4523-4529 (2005).
70 van Swieten, T. P. et al. Extending the dynamic temperature range of Boltzmann thermometers. Light: Science & Applications 11, 1-11 (2022).
71 McLellan, C. A. et al. Engineering Bright and Mechanosensitive Alkaline-Earth Rare-Earth Upconverting Nanoparticles. The Journal of Physical Chemistry Letters 13, 1547-1553 (2022).
72 Park, S.-H., Kwon, N., Lee, J.-H., Yoon, J. & Shin, I. Synthetic ratiometric fluorescent probes for detection of ions. Chemical Society Reviews 49, 143-179 (2020).
73 Runowski, M. et al. Lifetime nanomanometry—high-pressure luminescence of up-converting lanthanide nanocrystals—SrF 2: Yb 3+, Er 3+. Nanoscale 9, 16030-16037 (2017).
74 Dong, H., Sun, L.-D. & Yan, C.-H. Local structure engineering in lanthanide-doped nanocrystals for tunable upconversion emissions. Journal of the American Chemical Society 143, 20546-20561 (2021).
75. Ostrowski, A. D.; Chan, E. M.; Gargas, D. J.; Katz, E. M.; Han, G.; Schuck, P. J.; Milliron, D. J.; Cohen, B. E., Controlled synthesis and single-particle imaging of bright, sub-10 nm lanthanide-doped upconverting nanocrystals. ACS nano 2012, 6 (3), 2686-2692.
76. Chan, E. M.; Xu, C.; Mao, A. W.; Han, G.; Owen, J. S.; Cohen, B. E.; Milliron, D. J., Reproducible, high-throughput synthesis of colloidal nanocrystals for optimization in multidimensional parameter space. Nano letters 2010, 10 (5), 1874-1885.
77. Levy, E. S.; Tajon, C. A.; Bischof, T. S.; Iafrati, J.; Fernandez-Bravo, A.; Garfield, D. J.; Chamanzar, M.; Maharbiz, M. M.; Sohal, V. S.; Schuck, P. J., Energy-looping nanoparticles: harnessing excited-state absorption for deep-tissue imaging. ACS nano 2016, 10 (9), 8423-8433.
78. Wallace, A., Scanning Probe Microscopy. Analytical Geomicrobiology: A Handbook of Instrumental Techniques 2019, 121-147.
79. Xiao, C.; Shi, P.; Yan, W.; Chen, L.; Qian, L.; Kim, S. H., Thickness and structure of adsorbed water layer and effects on adhesion and friction at nanoasperity contact. Colloids and Interfaces 2019, 3 (3), 55.
80. Fischer, S.; Bronstein, N. D.; Swabeck, J. K.; Chan, E. M.; Alivisatos, A. P., Precise tuning of surface quenching for luminescence enhancement in core-shell lanthanide-doped nanocrystals. Nano letters 2016, 16 (11), 7241-7247.
81. Johnson, N. J.; He, S.; Diao, S.; Chan, E. M.; Dai, H.; Almutairi, A., Direct evidence for coupled surface and concentration quenching dynamics in lanthanide-doped nanocrystals. Journal of the American Chemical Society 2017, 139 (8), 3275-3282.
82. Zhao, J.; Chen, X.; Chen, B.; Luo, X.; Sun, T.; Zhang, W.; Wang, C.; Lin, J.; Su, D.; Qiao, X., Accurate control of core-shell upconversion nanoparticles through anisotropic strain engineering. Advanced Functional Materials 2019, 29 (44), 1903295.
83. Fischer, S.; Fröhlich, B.; Krämer, K. W.; Goldschmidt, J. C., Relation between excitation power density and Er3+ doping yielding the highest absolute upconversion quantum yield. The Journal of Physical Chemistry C 2014, 118 (51), 30106-30114.
84. Grzechnik, A.; Bouvier, P.; Mezouar, M.; Mathews, M.; Tyagi, A.; Köhler, J., Hexagonal Na1. 5Y1. 5F6 at high pressures. Journal of Solid State Chemistry 2002, 165 (1), 159-164.
85. Lay, A.; Wang, D. S.; Wisser, M. D.; Mehlenbacher, R. D.; Lin, Y.; Goodman, M. B.; Mao, W. L.; Dionne, J. A., Upconverting nanoparticles as optical sensors of nano-to micro-Newton forces. Nano letters 2017, 17 (7), 4172-4177.
86. Casar, J. R.; McLellan, C. A.; Siefe, C.; Dionne, J. A., Lanthanide-based nanosensors: refining nanoparticle responsiveness for single particle imaging of stimuli. ACS photonics 2020, 8 (1), 3-17.
87. McLellan, C. A.; Siefe, C.; Casar, J. R.; Peng, C. S.; Fischer, S.; Lay, A.; Parakh, A.; Ke, F.; Gu, X. W.; Mao, W., Engineering Bright and Mechanosensitive Alkaline-Earth Rare-Earth Upconverting Nanoparticles. The Journal of Physical Chemistry Letters 2022, 13 (6), 1547-1553.
88. Dréau, A.; Lesik, M.; Rondin, L.; Spinicelli, P.; Arcizet, O.; Roch, J.-F.; Jacques, V., Avoiding power broadening in optically detected magnetic resonance of single NV defects for enhanced dc magnetic field sensitivity. Physical Review B 2011, 84 (19), 195204.
89. Taylor, J. M.; Cappellaro, P.; Childress, L.; Jiang, L.; Budker, D.; Hemmer, P.; Yacoby, A.; Walsworth, R.; Lukin, M., High-sensitivity diamond magnetometer with nanoscale resolution. Nature Physics 2008, 4 (10), 810-816.
90. Lay, A.; Sheppard, O. H.; Siefe, C.; McLellan, C. A.; Mehlenbacher, R. D.; Fischer, S.; Goodman, M. B.; Dionne, J. A., Optically robust and biocompatible mechanosensitive upconverting nanoparticles. ACS central science 2019, 5 (7), 1211-1222.
91. Rabier, J.; Renault, P.; Eyidi, D.; Demenet, J.; Chen, J.; Couvy, H.; Wang, L., Plastic deformation of silicon between 20 C and 425 C. physica status solidi c 2007, 4 (8), 3110-3114.
92. Wisser, M. D.; Chea, M.; Lin, Y.; Wu, D. M.; Mao, W. L.; Salleo, A.; Dionne, J. A., Strain-induced modification of optical selection rules in lanthanide-based upconverting nanoparticles. Nano letters 2015, 15 (3), 1891-1897.
93. Lee, C.; Xu, E. Z.; Liu, Y.; Teitelboim, A.; Yao, K.; Fernandez-Bravo, A.; Kotulska, A. M.; Nam, S. H.; Suh, Y. D.; Bednarkiewicz, A., Giant nonlinear optical responses from photon-avalanching nanoparticles. Nature 2021, 589 (7841), 230-235.

What is claimed is:

1. A device, comprising:
a remote optical sensor configured to measure a force in the nanonewton range.

2. The device of claim 1, wherein the remote optical sensor uses avalanching nanoparticles to measure the force in the nanonewton range.

3. The device of claim 2, wherein the avalanching nanoparticles become brighter as the force is applied.

4. The device of claim 2, wherein the avalanching nanoparticles become dimmer as the force is applied.

5. The device of claim 2, wherein the remote optical sensor provides information to an analysis device which is configured analyze the one or more values which correlated to the brightness of the avalanching nanoparticles.

6. A device, comprising:
a remote optical sensor configured to measure a force in the piconewton range,
wherein the remote optical sensor is configured to provide one or more specific force values for the measured force within the piconewton range.

7. The device of claim 6, wherein the remote optical sensor uses avalanching nanoparticles to measure the force in the piconewton range.

8. The device of claim 7, wherein the avalanching nanoparticles become brighter as the force is applied.

9. The device of claim 7, wherein the avalanching nanoparticles become dimmer as the force is applied.

10. The device of claim 7, wherein the remote optical sensor provides the one or more specific force values to an analysis device which is configured analyze the one or more values which correlated to the brightness of the avalanching nanoparticles.

11. A device, comprising:
a remote optical sensor configured to measure a force in a near infrared (IR) wavelength range.

12. The device of claim 11, wherein the remote optical sensor uses avalanching nanoparticles to measure the force.

13. The device of claim 12, wherein the avalanching nanoparticles become brighter as the force is applied.

14. The device of claim 12, wherein the avalanching nanoparticles become dimmer as the force is applied.

15. The device of claim 12, wherein the measured force is correlated to the brightness of the avalanching nanoparticles.

16. The device of claim 11, wherein an operation of the remote optical sensor in the near IR wavelength range facilitates a subsurface force measurement thereby.

17. A device for measuring a force, comprising:
a remote optical configured to operate on at least two discrete wavelengths so as to measure the force.

18. The device of claim 17, wherein the at least two discrete wavelengths provide a ratio-metric readout of force.

19. A method for measuring a force, comprising:
providing, to an object, a plurality of remote optical sensors positioned about 50-100 nm apart, and
generating a pressure map of the force across at least one portion of the object based on individual pressure readings from each of the plurality of remote optical sensors.

20. The method of claim 19, wherein the pressure map is generated on or in an internal portion of the object.

21. The method of claim 19, wherein the pressure map is generated on a surface of the object.

22. A system, comprising:
a remote optical sensor configured to measure a force in the nanonewton range; and
a computer processor configured to correlate a brightness output of the remote optical sensor to the measured force.
